(19) United States
(12) Patent Application Publication
(10) Pub. No.: US 2025/0251538 A1
(43) Pub. Date: Aug. 7, 2025

(54) POLARIZING FILMS AND METHODS FOR PREPARING THEREOF, OPTICAL WAVEGUIDE LENSES, AND DISPLAY DEVICES

(71) Applicants: SVG TECH GROUP CO., LTD., Suzhou (CN); SOOCHOW UNIVERSITY, Suzhou (CN)

(72) Inventors: Minghui LUO, Suzhou (CN); Zhen ZHOU, Suzhou (CN); Wen QIAO, Suzhou (CN); Linsen CHEN, Suzhou (CN)

(73) Assignees: SVG TECH GROUP CO., LTD., Suzhou (CN); SOOCHOW UNIVERSITY, Suzhou (CN)

(21) Appl. No.: 19/091,801

(22) Filed: Mar. 26, 2025

Related U.S. Application Data
(63) Continuation of application No. PCT/CN2023/077336, filed on Feb. 21, 2023.

(30) Foreign Application Priority Data
Sep. 27, 2022 (CN) 202211181334.4

(51) Int. Cl. G02B 5/30; G02B 1/14; G02B 5/18; G02B 6/126

(52) U.S. Cl. CPC G02B 5/30; G02B 1/14; G02B 5/1857; G02B 5/1866; G02B 6/126

(57) ABSTRACT

Embodiments of the present disclosure provide a method for preparing a polarizing film, a display device, and an optical waveguide lens. The polarizing film includes: a transparent substrate; a grating layer disposed on the transparent substrate, the grating layer including dielectric gratings and metallic layers periodically arranged at intervals along a direction parallel to a surface of the transparent substrate; and a protective layer covering the grating layer. Embodiments of the present disclosure also provide a polarizing film of a novel structure, which, by carrying out the above-described optimized design of the structure of the grating layer and the protective layer, is able to take into account the optical performance of low absorption loss, high extinction ratio, and wide incident angle, and is It is favorable for a wide range of applications. In addition, embodiments of the present disclosure relate to a method of making the above-described polarizing film, and an optical waveguide lens and a display device including the above-described polarizing film.

### CROSS-REFERENCE TO RELATED APPLICATIONS

This application is a Continuation of International Application No. PCT/CN2023/077336, filed on Feb. 21, 2023, which claims priority of Chinese patent Application No. 202211181334.4, filed on Sep. 27, 2022, the entire contents of which are incorporated herein by reference.

### TECHNICAL FIELD

The present disclosure relates to the field of display technology, and in particular relates to a polarizing film, a method for preparing a polarizing film, a display device, and an optical waveguide lens.

### BACKGROUND

The polarizing film is a very important optical component used in systems such as liquid crystal displays, optical measurements, and optical communications, and are ideally suited for applications that require high contrast polarization, such as micro-projectors, polarizing beam splitter prisms, and display devices such as heads-up displays. High extinction ratios, a wide range of incident angles, and very compact sizes are required for the polarizing film in these systems. The polarizing film is designed to transmit desired polarization states while reflecting unwanted states, while achieving spectrally flat performance at incident angles of up to 45°, and is therefore widely used as a polarizing beam splitter prism. Additionally, a polarizing reflective film based on metallic wire grids provides durability at high temperatures or high humidity, and excellent polarization beam-splitting performance in the visible and near-infrared spectral range from 400 nm to 1200 nm.

However, conventional polarizing films are unable to combine optical properties such as low absorption loss, high extinction ratio, and wide incident angle, which is not conducive to a wide range of applications.

### SUMMARY

Based on this, there is a need to provide, in response to the problem of how to combine optical properties of low absorption loss, high extinction ratio, and wide incident angle, a polarizing film capable of combining the optical properties of low absorption loss, high extinction ratio, and wide incident angle, and a method for preparing a polarizing film, an optical waveguide lens, and display device.

One or more embodiments of the present disclosure provide a polarizing film, the polarizing film includes: a transparent substrate; a grating layer disposed on the transparent substrate, the grating layer including dielectric gratings and metallic layers periodically arranged at intervals along a direction parallel to a surface of the transparent substrate; and a protective layer covering the grating layer.

One or more embodiments of the present disclosure further provide a method for preparing a polarizing film, includes: forming a grating layer on a transparent substrate, wherein the grating layer includes dielectric gratings and metallic layers periodically arranged at intervals along a direction parallel to a surface of the transparent substrate, and the dielectric gratings and the metallic layers have identical thicknesses; and forming a protective layer on the grating layer to obtain the polarizing film.

One or more embodiments of the present disclosure further provide a display device including a polarizing film of any of the foregoing; the display device being a projector, a polarizing beam splitter prism, or a heads-up display.

One or more embodiments of the present disclosure provide an optical waveguide lens, including: an optical waveguide having a light-receiving surface configured to receive light and a backlight surface disposed opposite the light-receiving surface; and the polarizing film of above-mentioned on the backlight surface of the optical waveguide, wherein the transparent substrate of the polarizing film is arranged away from the optical waveguide; wherein a gap is between the optical waveguide and the polarizing film.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating optical properties of a polarizing film according to some embodiments of the present disclosure;

FIG. 2 is a schematic structural diagram illustrating a polarizing film according to some embodiments of the present disclosure;

FIG. 3 is a flowchart illustrating a method for preparing a polarizing film according to some embodiments of the present disclosure;

FIG. 4 is a schematic diagram illustrating an overall optical waveguide lens according to some embodiments of the present disclosure;

FIG. 5 is a schematic diagram illustrating light of an optical waveguide lens according to some embodiments of the present disclosure;

FIG. 6 is a schematic diagram illustrating transmittance spectrums of a polarizing film at normal incidence of P-polarized light and S-polarized light according to an embodiment 1 of the present disclosure;

FIG. 7 is a schematic diagram illustrating transmittance spectrums of a polarizing film at different incident angles of P-polarized light and S-polarized light according to an embodiment 1 of the present disclosure;

FIG. 8 is a schematic diagram illustrating reflectance spectrums of P-polarized light and S-polarized light of a polarizing film according to an embodiment 1 of the present disclosure;

FIG. 9 is a schematic diagram illustrating transmittance spectrums of a polarizing film at a 0° incident angle of P-polarized light and S-polarized light in a visible wavelength range according to embodiments 2-6 of the present disclosure;

FIG. 10 is a schematic diagram illustrating transmittance spectrums of a polarizing film at a 0° incident angle of P-polarized light and S-polarized light in a visible wavelength range according to embodiments 7-11 of the present disclosure;

FIG. 11 is a schematic diagram illustrating transmittance spectrums of a polarizing film at a 0° incident angle of P-polarized light and S-polarized light in a visible wavelength range according to embodiments 12-16 of the present disclosure;

FIG. 12 is a schematic diagram illustrating transmittance spectrums of a polarizing film at a 0° incident angle of P-polarized light and S-polarized light in a visible wavelength range according to embodiment 1 and embodiments 17-20 of the present disclosure;

FIG. 13 is a schematic diagram illustrating transmittance spectrums of a polarizing film at normal incidence of P-polarized light and S-polarized light according to an embodiment 17 of the present disclosure;

FIG. 14 is a schematic diagram illustrating transmittance spectrums of a polarizing film at normal incidence of P-polarized light and S-polarized light according to an embodiment 18 of the present disclosure;

FIG. 15 is a schematic diagram illustrating transmittance spectrums of a polarizing film at normal incidence of P-polarized light and S-polarized light according to an embodiment 19 of the present disclosure;

FIG. 16 is a schematic diagram illustrating transmittance spectrums of a polarizing film at normal incidence of P-polarized light and S-polarized light according to an embodiment 20 of the present disclosure;

FIG. 17 is a schematic diagram illustrating transmittance spectrums of a polarizing film at different incident angles of P-polarized light and S-polarized light according to an embodiment 17 of the present disclosure;

FIG. 18 is a schematic diagram illustrating transmittance spectrums of a polarizing film at different incident angles of P-polarized light and S-polarized light according to an embodiment 18 of the present disclosure;

FIG. 19 is a schematic diagram illustrating transmittance spectrums of a polarizing film at different incident angles of P-polarized light and S-polarized light according to an embodiment 19 of the present disclosure;

FIG. 20 is a schematic diagram illustrating transmittance spectrums of a polarizing film at different incident angles of P-polarized light and S-polarized light according to an embodiment 20 of the present disclosure;

FIG. 21 is a schematic diagram illustrating transmittance spectrums of a polarizing film at a 0° incident angle of P-polarized light and S-polarized light in a visible wavelength range according to an embodiment 1 and embodiments 21-24 of the present disclosure;

FIG. 22 is a schematic diagram illustrating transmittance spectrums of a polarizing film at normal incidence of P-polarized light and S-polarized light according to an embodiment 21 of the present disclosure;

FIG. 23 is a schematic diagram illustrating transmittance spectrums of a polarizing film at normal incidence of P-polarized light and S-polarized light according to an embodiment 22 of the present disclosure;

FIG. 24 is a schematic diagram illustrating transmittance spectrums of a polarizing film at normal incidence of P-polarized light and S-polarized light according to an embodiment 23 of the present disclosure;

FIG. 25 is a schematic diagram illustrating transmittance spectrums of a polarizing film at normal incidence of P-polarized light and S-polarized light according to an embodiment 24 of the present disclosure;

FIG. 26 is a schematic diagram illustrating transmittance spectrums of a polarizing film at different incident angles of P-polarized light and S-polarized light according to an embodiment 21 of the present disclosure;

FIG. 27 is a schematic diagram illustrating transmittance spectrums of a polarizing film at different incident angles of P-polarized light and S-polarized light according to an embodiment 22 of the present disclosure;

FIG. 28 is a schematic diagram illustrating transmittance spectrums of a polarizing film at different incident angles of P-polarized light and S-polarized light according to an embodiment 23 of the present disclosure;

FIG. 29 is a schematic diagram illustrating transmittance spectrums of a polarizing film at different incident angles of P-polarized light and S-polarized light according to an embodiment 24 of the present disclosure;

FIG. 30 is a schematic diagram illustrating transmittance spectrums of a polarizing film at a 0° incident angle of P-polarized light and S-polarized light in a visible wavelength range according to an embodiment 1 and embodiments 25-28 of the present disclosure;

FIG. 31 is a schematic diagram illustrating transmittance spectrums of a polarizing film at normal incidence of P-polarized light and S-polarized light according to an embodiment 25 of the present disclosure;

FIG. 32 is a schematic diagram illustrating transmittance spectrums of a polarizing film at normal incidence of P-polarized light and S-polarized light according to an embodiment 26 of the present disclosure;

FIG. 33 is a schematic diagram illustrating transmittance spectrums of a polarizing film at normal incidence of P-polarized light and S-polarized light according to an embodiment 27 of the present disclosure;

FIG. 34 is a schematic diagram illustrating transmittance spectrums of a polarizing film at normal incidence of P-polarized light and S-polarized light according to an embodiment 28 of the present disclosure;

FIG. 35 is a schematic diagram illustrating transmittance spectrums of a polarizing film at different incident angles of P-polarized light and S-polarized light according to an embodiment 25 of the present disclosure;

FIG. 36 is a schematic diagram illustrating transmittance spectrums of a polarizing film at different incident angles of P-polarized light and S-polarized light according to an embodiment 26 of the present disclosure;

FIG. 37 is a schematic diagram illustrating transmittance spectrums of a polarizing film at different incident angles of P-polarized light and S-polarized light according to an embodiment 27 of the present disclosure;

FIG. 38 is a schematic diagram illustrating transmittance spectrums of a polarizing film at different incident angles of P-polarized light and S-polarized light according to an embodiment 28 of the present disclosure; and

FIG. 39 is a schematic diagram illustrating transmittance spectrums of a polarizing film at a 0° incident angle of P-polarized light and S-polarized light in a visible wavelength range according to embodiments 29-33 of the present disclosure.

### DETAILED DESCRIPTION

In the following detailed description, numerous specific details are set forth by way of embodiments in order to provide a thorough understanding of the relevant disclosure. Obviously, drawings described below are only some embodiments or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It should be noted that when a component is referred to as “fixed to” another component, it can be directly on the other component or there can also be a centered component. When a component is considered to be “connected” to another component, it can be directly connected to another component or there may be a central component present at the same time. The terms “vertical,” “horizontal,” “left,” “right,” and similar expressions used in this article are for illustrative purposes only.

Unless otherwise defined, all technical and scientific terms used in this article have the same meanings as those commonly understood by those skilled in the art belonging to the present invention. The terms used in the present disclosure are only for the purpose of describing specific embodiments, and are not intended to limit the present invention. The term “and/or” used in this article includes any and all combinations of one or more related listed items.

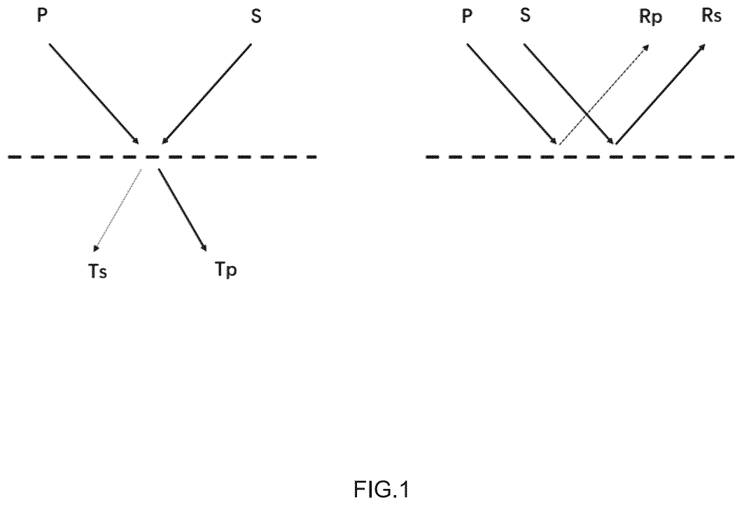

FIG. 1 is a schematic diagram illustrating optical properties of a polarizing film according to some embodiments of the present disclosure. When the incident light containing S-polarized light and P-polarized light is incident on the polarizing film, the P-polarized light may have a relatively high transmittance Tp and the S-polarized light may have a relatively low transmittance Ts; at the same time, the P-polarized light may have a relatively low reflectance Rp, and the S-polarized light may have a relatively high reflectance Rs.

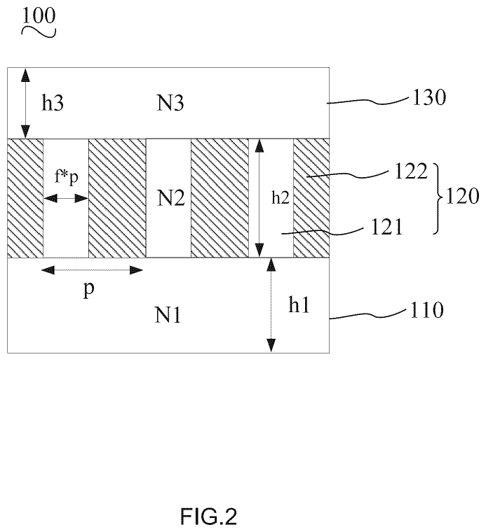

FIG. 2 is a schematic structural diagram illustrating a polarizing film according to some embodiments of the present disclosure.

As shown in FIG. 2, some embodiments of the present disclosure provide a polarizing film 100 including a transparent substrate 110, a grating layer 120, and a protective layer 130.

The polarizing film 100 is an optical element that enables selective transmission of light based on a polarization state of the light.

The transparent substrate 110 is a base structure for the polarizing film that may host structures such as the grating layer 120.

The grating layer 120 is a grating structure for selecting light rays for transmission.

The protective layer 130 is a protective structure that protects the grating layer 120 and the transparent substrate 110 from external damage.

In some embodiments, the grating layer 120 is disposed on the transparent substrate 110, and the grating layer 120 includes a dielectric grating 121 and a metallic layer 122 disposed periodically arranged at intervals along a direction parallel to a surface of the transparent substrate 110.

In some embodiments, the dielectric grating 121 and the metallic layer 122 have identical thicknesses h2.

In some embodiments, the thicknesses h2 of the dielectric grating 121 and the metallic layer 122 may also be different.

In some embodiments, the protective layer 130 covers the grating layer 120.

In some embodiments, the transparent substrate 110 provides support for the grating layer 120 and the protective layer 130 disposed in the upper layer, and a transmittance of the transparent substrate 110 in visible light is greater than 80%.

In some embodiments, the protective layer 130 is configured to protect the transparent substrate 110 and the grating layer 120, and may prevent oxidation of the metallic layer 122.

In some embodiments, a period of the dielectric grating 121 is in a range of 50 nm-150 nm, a duty cycle of the dielectric grating 121 is in a range of 0.25-0.75, and the thickness of the dielectric grating 121 is in a range of 60 nm-200 nm.

In some embodiments, the period of the dielectric grating 121 is in a range of 50 nm, 60 nm, 70 nm, 80 nm, 90 nm, 100 nm, 110 nm, 120 nm, 130 nm, 140 nm, or 150 nm.

In some embodiments, the period of the dielectric grating 121 may also be at least one of 50 nm-80 nm, 50 nm-100 nm, 70 nm-90 nm, 80 nm-100 nm, 90 nm-120 nm, 100 nm-130 nm, 100 nm-150 nm, or 120 nm-150 nm.

The duty cycle of the dielectric grating is a ratio of the width of the dielectric grating to its period.

In some embodiments, the duty cycle of the dielectric grating 121 may be at least one of 0.25, 0.30, 0.35, 0.40, 0.45, 0.50, 0.55, 0.60, 0.65, 0.70, or 0.75.

In some embodiments, the duty cycle of the dielectric grating 121 may also be at least one of 0.25-0.35, 0.25-0.5, 0.35-0.5, 0.35-0.65, 0.45-0.55, 0.5-0.65, 0.5-0.75, or 0.65-0.75.

In some embodiments, the thickness of the dielectric grating 121 may be at least one of 60 nm, 70 nm, 80 nm, 90 nm, 100 nm, 110 nm, 120 nm, 130 nm, 140 nm, 150 nm, 160 nm, 170 nm, 180 nm, 190 nm, or 200 nm.

In some embodiments, the thickness of the dielectric grating 121 may also be at least one of 60 nm-140 nm, 90 nm-140 nm, 120 nm-140 nm, 120 nm-160 nm, 100 nm-180 nm, 140 nm-200 nm, 160 nm-200 nm, or 180 nm-200 nm.

In some embodiments, the period of the dielectric grating, the duty cycle of the dielectric grating, and the thickness of the dielectric grating may also be determined based on actual application scenarios and needs.

In some embodiments, the material of the dielectric grating 121 is a resin-based curing adhesive. For example, the resin-based curing adhesive may be a UV adhesive or it may be other resin-based curing adhesive.

In some embodiments, the dielectric grating and the metallic layer have the identical thicknesses.

In some embodiments, when the thickness of the dielectric grating is in the range of 60 nm-200 nm, the thickness of the metallic layer 122 is also in the range of 60 nm-200 nm.

In some embodiments, the thickness of the metallic layer 122 may be at least one of 60 nm, 70 nm, 80 nm, 90 nm, 100 nm, 110 nm, 120 nm, 130 nm, 140 nm, 150 nm, 160 nm, 170 nm, 180 nm, 190 nm, or 200 nm.

In some embodiments, the thickness of the metallic layer 122 may also be at least one of 60 nm-140 nm, 90 nm-140 nm, 120 nm-140 nm, 120 nm-160 nm, 100 nm-180 nm, 140 nm-200 nm, 160 nm-200 nm, or 180 nm-200 nm.

In some embodiments, the thickness of the metallic layer 122 may also be determined based on actual application scenarios and needs.

In some embodiments, a refractive index N1 of the transparent substrate 110 is in a range of 1.4-2 and a refractive index N2 of the dielectric grating 121 is in a range of 1.4-2.

In some embodiments, the refractive index N1 of the transparent substrate 110 may be at least one of 1.4, 1.5, 1.6, 1.7, 1.8, 1.9, or 2.

In some embodiments, the refractive index N1 of the transparent substrate 110 may also be at least one of 1.4-1.7, 1.5-1.7, 1.5-1.9, 1.6-1.8, 1.7-2, 1.8-2, or 1.9-2.

In some embodiments, the refractive index N2 of the dielectric grating 121 may be at least one of 1.4, 1.5, 1.6, 1.7, 1.8, 1.9, or 2.

In some embodiments, the refractive index N2 of the dielectric grating 121 may also be at least one of 1.4-1.7, 1.5-1.7, 1.5-1.9, 1.6-1.8, 1.7-2, 1.8-2, or 1.9-2.

In some embodiments, the refractive index N1 of the transparent substrate and the refractive index N2 of the dielectric grating may also be determined according to the actual application scenarios and needs.

According to some embodiments of the present disclosure, by setting the period, duty cycle, thickness, and material of the dielectric grating, the refractive index of the transparent substrate and the dielectric grating, or the like, the optical performance of the polarizing film can be optimized, and the polarization effect can be improved, so as to enhance the display effect and the visual experience.

In some embodiments, the material of the flexible substrate may be determined according to the actual application scenario and needs, such as a rigid substrate, a semi-flexible substrate, or the like.

In some embodiments, the transparent substrate 110 is a flexible substrate.

According to some embodiments of the present disclosure, by setting the transparent substrate 110 as a flexible substrate, it is able to be applied to the flexible manufacturing of the polarizing film, and be applied to the scenarios where the flexible polarizing film is required, and thus expand the scope of the application of the polarizing film.

In some embodiments, the material of the flexible substrate may be an organic polymer.

In some embodiments, the material of the flexible substrate may be at least one of polycarbonate (PC), polyvinyl chloride (PVC), polyethylene terephthalate (PET), polymethylmethacrylate (PMMA), polypropylene (PP), and cellulose triacetate (TAC).

In some embodiments, the material of the flexible substrate may also be determined based on actual application scenarios and needs.

According to some embodiments of the present disclosure, by setting the type of material of the flexible substrate, it can be ensured that the flexible substrate has a better flexibility, and also has a higher transmittance, which can improve the performance of the polarizing film.

In some embodiments, a thickness of the transparent substrate 110 is in a range of 0.01 mm-1 mm.

In some embodiments, the thickness of the transparent substrate 110 may be at least one of 0.01 mm, 0.1 mm, 0.2 mm, 0.3 mm, 0.4 mm, 0.5 mm, 0.6 mm, 0.7 mm, 0.8 mm, 0.9 mm, or 1 mm.

In some embodiments, the thickness of the transparent substrate 110 may be at least one of 0.01 mm-0.5 mm, 0.01 mm-0.8 mm, 0.1 mm-0.5 mm, 0.1 mm-0.8 mm, 0.3 mm-0.8 mm, 0.5 mm-0.8 mm, 0.5 mm-1 mm, or 0.7 mm-1 mm.

In some embodiments, the thickness of the transparent substrate 110 may also be determined based on actual application scenarios and needs.

According to some embodiments of the present disclosure, by setting the thickness of the transparent substrate, it is possible to ensure the structural strength of the transparent substrate while maintaining sufficient light transmittance, and thus ensure the optical effect of the polarizing film.

In some embodiments, the refractive index N3 of the protective layer 130 is in a range of 1.3-1.8, and the thickness of the protective layer 130 is in a range of 50 nm-200 nm.

In some embodiments, the refractive index N3 of the protective layer 130 may be at least one of 1.3, 1.4, 1.5, 1.6, 1.7, or 1.8.

In some embodiments, the refractive index N3 of the protective layer 130 may also be at least one of 1.3-1.5, 1.3-1.7, 1.4-1.6, 1.4-1.7, 1.4-1.8, 1.5-1.7, or 1.5-1.8.

In some embodiments, the thickness of the protective layer 130 may be at least one of 50 nm, 75 nm, 100 nm, 125 nm, 150 nm, 175 nm, and 200 nm.

In some embodiments, the thickness of the protective layer 130 may also be at least one of 50 nm-125 nm, 50 nm-175 nm, 50 nm-125 nm, 100 nm-150 nm, 175 nm-175 nm, and 150 nm-200 nm.

In some embodiments, the refractive index and the thickness of the protective layer may also be determined based on actual application scenarios and needs.

In some embodiments, the material of the protective layer 130 may be determined based on actual application scenarios and needs. For example, the material of the protective layer 130 may be an inorganic material.

In some embodiments, the material of the protective layer 130 is at least one of silicon dioxide (SiO₂₎, magnesium fluoride (MgF₂), and silicon oxynitride (SiON).

According to some embodiments of the present disclosure, by setting the refractive index, the thickness, and the material of the protective layer, it is possible to make the protective layer have good optical properties and chemical stability.

In some embodiments of the present disclosure, the metallic layer 122 may be made of at least one of gold, silver, copper, aluminum, and tungsten.

In some embodiments of the present disclosure, the material of the metallic layer 122 may also be determined based on actual application scenarios and needs.

In some embodiments of the present disclosure, the type of polarizing film includes but is not limited to, a reflective film, a transmissive film, a diffractive film, or the like.

In some embodiments of the present disclosure, the grating structure of the polarizing film is alternately set with a dielectric grating and a metallic layer, and due to the different refractive indices of the dielectric grating and the metallic layer, the values of the equivalent refractive indices of the S-polarized light and the P-polarized light are not the same. When the S-polarized light irradiates the grating structure, the electrons of the metallic layer form an enhanced free oscillation in the direction of the grating line, causing the S-polarized light to form an enhanced reflection; when the P-polarized light is irradiated, the electron oscillation through the direction of the grating line is impeded, and then the transmission of the P-polarized light is enhanced, and therefore, the polarizing film of the present disclosure has the optical performance of reducing the absorption loss and improving the extinction ratio. In addition, the polarizing film designed in the present disclosure has a large angular tolerance, which is very suitable for large angle applications. Therefore, it is able to take into account the optical performances of low absorption loss, high extinction ratio, and wide incident angle, which is favorable for a wide range of applications.

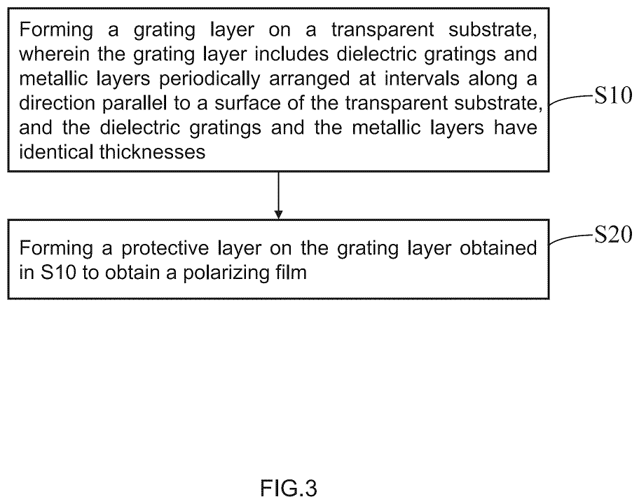

FIG. 3 is a flowchart illustrating a method for preparing a polarizing film according to some embodiments of the present disclosure. As shown in FIG. 3, the method of preparing the polarizing film includes the following operations:

S10, forming a grating layer on a transparent substrate, wherein the grating layer includes dielectric gratings and metallic layers periodically arranged at intervals along a direction parallel to a surface of the transparent substrate, and the dielectric gratings and the metallic layers have identical thicknesses.

In some embodiments of the present disclosure, the dielectric grating and the metallic layer may be set by a variety of manners. For example, the metallic layer and the dielectric grating may be deposited on the transparent substrate by electron beam evaporation, chemical vapor deposition, resistive evaporation coating, or the like, thereby forming a periodically arranged structure.

In some embodiments of the present disclosure, in S10, the operation of forming the grating layer on the transparent substrate includes: forming the dielectric gratings periodically arranged at intervals along the direction parallel to the surface of the transparent substrate via nanoimprint lithography, wherein a groove is between two adjacent dielectric gratings; and forming a metallic layer precursor on the dielectric gratings via a coating process, and removing the metallic layer precursor on a side of the dielectric gratings away from the transparent substrate while retaining the metallic layer precursor in the groove to form the metallic layers.

The nanoimprint lithography is a manner of imprinting nanostructured patterns on a mold onto a substrate by physical imprinting. The coating process is a process in which a thin film is deposited on a deposition surface by physical or chemical means. In some embodiments of the present disclosure, the coating process may be an electron beam evaporation process.

In some embodiments of the present disclosure, the dielectric grating is fabricated by the nanoimprint lithography, and the metallic layer is formed on the dielectric grating by the coating process, which can accurately control the distribution of the dielectric grating and the metallic layer in the grating layer, thereby enhancing the optical reflectance of the grating layer and the transmission features.

In some embodiments of the present disclosure, the operations of forming the dielectric gratings periodically arranged at intervals along the direction parallel to the surface of the transparent substrate via nanoimprint lithography includes: bonding the transparent substrate to an imprinting template, wherein an imprinting adhesive is covered between the transparent substrate and the imprinting template; pressing the transparent substrate and the imprinting template together; curing the imprinting adhesive; and demolding the imprinting template from the cured imprinting adhesive to form the dielectric gratings periodically arranged at intervals along the direction parallel to the surface of the transparent substrate.

The imprinting template is a rigid master template having a grooved structure, and the grooved structure matches the structure and size of the dielectric grating.

In some embodiments of the present disclosure, an imprinting adhesive may be applied to the transparent substrate or transparent substrate prior to laminating the transparent substrate to the transparent substrate.

The imprinting adhesive refers to a curable polymer that fills the grooved structure. In some embodiments of the present disclosure, the imprinting adhesive may include a thermosetting resin or photosetting resin, such as epoxy resin, acrylate resin.

In some embodiments of the present disclosure, other feasible manners may be configured to form a dielectric grating on a transparent substrate.

In some embodiments of the present disclosure, the coating process may be an electron beam evaporation process. The specific operation of the coating process is as follows: the transparent substrate and the dielectric grating are attached to the fixture with high-temperature adhesive tape, and then put into the coating equipment together, after which the vacuum is pumped in, O2 and Ar2 are passed in, and the coating parameters are set (including the type of the coating, the coating time, and the coating rate, etc.), and a metallic layer is formed on the dielectric grating after the coating is completed. The coating parameters may be determined based on actual application scenarios and needs.

In some embodiments of the present disclosure, a metallic layer precursor on the side of the dielectric grating away from the transparent substrate may be removed by a polishing process. For example, chemical-mechanical polishing manner (CMP) was used with the following polishing parameters: the film layer was Al, the film thickness was 100 nm-200 nm, the grinding duration was 10 min-40 min, the polishing solution for aluminum was selected, the polishing disc speed was 40 r/min, the sample speed was 60 r/min, the homogeneity was <5%, and the surface roughness was 1 nm-10 nm. The polishing parameters may be determined based on actual application scenarios and needs.

S20, forming a protective layer on the grating layer obtained in S10 to obtain a polarizing film.

In some embodiments, the operation of forming a protective layer on the dielectric grating and the metallic layer in S20 is: forming a protective layer on the dielectric grating and the metallic layer by a coating process.

In some embodiments, the coating process may be a thermal evaporation process.

In some embodiments, the coating parameters are as follows: SiO₂ plating with a coating thickness of 5 nm-200 nm, a coating rate of 0.1 A/S-10 A/S, an operating vacuum of 5E-6 Torr, and a coating time of 1 min-60 min.

In some embodiments, the coating parameters may also be determined based on actual application scenarios and needs.

In some embodiments of the present disclosure, a new type of structured polarizing film can be produced by adopting the above-described manner of producing a polarizing film, and it is verified after testing that the new type of structured polarizing film can take into account optical properties such as low absorption loss, high extinction ratio, and a wide incident angle of optical performance, which is conducive to wide application.

A display device (not shown) of an embodiment of the present disclosure includes a polarizing film of any of the foregoing.

In some embodiments, the display device is a projector, a polarizing beam splitter prism, or a heads-up display. For example, a projection optical system, an AR/VR system, a television, a computer, a consumer electronic display device, or polarized glasses.

In some embodiments of the present disclosure, by applying a polarizing film to a display device, such as a projector, a polarizing beam splitter prism, or a heads-up display, the display effect and the visual experience can be significantly improved.

Some embodiments of the present disclosure further provide an optical waveguide lens including a polarizing film as described above.

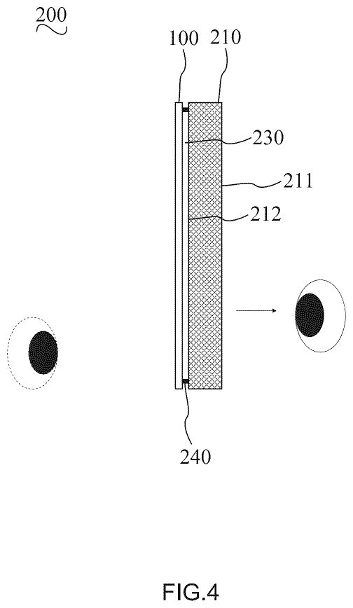

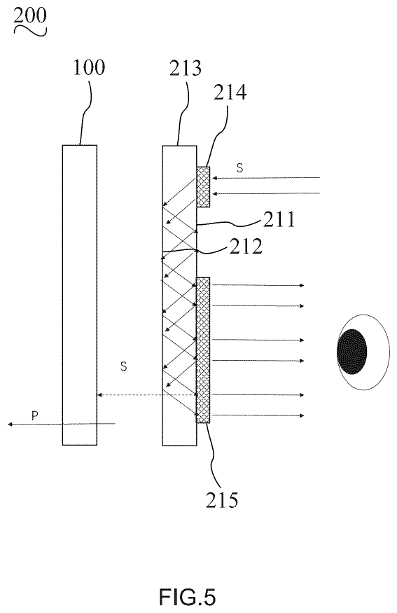

FIG. 4 is a schematic diagram illustrating an overall optical waveguide lens according to some embodiments of the present disclosure; and FIG. 5 is a schematic diagram illustrating light of an optical waveguide lens according to some embodiments of the present disclosure.

In some embodiments, the optical waveguide lens 200, as shown in FIG. 4 and FIG. 5, includes an optical waveguide 210 and a polarizing film 100 as described above.

The optical waveguide 210 is an optical element that guides light along a preset path.

In some embodiments, the optical waveguide 210 includes a light-receiving surface 211 for receiving light and a backlight surface 212 disposed on the other side of the light-receiving surface 211.

In some embodiments, the polarizing film 100 is configured to reflect S-polarized light and transmit P-polarized light; the polarizing film 100 is disposed on the backlight surface 212 of the optical waveguide 210, and a transparent substrate of the polarizing film 100 is disposed away from the optical waveguide 210.

In some embodiments, the optical waveguide 210 has a gap 230 between the optical waveguide 210 and the polarizing film 100.

In some embodiments, the optical waveguide 210 includes an optical waveguide body 213, and two functional regions are present on the surface of the optical waveguide body 213, a coupling-in region 214 and a coupling-out region 215. The light beam is first projected to the coupling-in region 214, and through grating diffraction and waveguide total reflection, the coupled light beam enters the coupling-out region 215, and outputs the light beam to the human eye in a certain direction, realizing the augmented reality display of the holographic diffraction waveguide lens. Alternatively, the image light is incident from the waveguide lens coupling-in region 214, and the coupling-out region 215 is outgoing, realizing a horizontally oriented field of view expansion. In some embodiments, the shape of the two functional regions described above may be circular, rectangular, conical, or the like.

In some embodiments, the shapes of both functional regions may be determined based on actual application scenarios and needs.

In some embodiments, the surface of the optical waveguide body 213 may also define other functional regions based on actual application scenarios and needs.

In some embodiments of the present disclosure, the polarizing film 100 may block light rays from the optical waveguide 210 to the backlight surface 212. In some embodiments, the polarizing film 100 is equipped with the function of polarization beam splitting. The light polarized by the S-polarized light has a lower transmittance, so that the front projection light cannot be received through the polarizing film 100; while the light polarized by the P-polarized light has a higher transmittance, so that the P-polarized light in the ambient light may be received through the polarizing film 100 by the observer, so that it does not affect the view of reality of the observer.

In some embodiments, the optical waveguide 210 has a gap 230 between the optical waveguide 210 and the polarizing film 100, which may prevent the polarizing film from affecting the optical waveguide imaging.

In some embodiments, the interior of the gap 230 is air.

In some embodiments, the interior of the gap 230 may also be filled with other gases that do not interfere with the imaging of the optical waveguide.

In some embodiments, the polarizing film 100 has a transmittance of less than 5% for S-polarized light and the polarizing film 100 has a transmittance of greater than or equal to 60% for P-polarized light.

In some embodiments, the transmittance of the polarizing film 100 for S-polarized light may be at least one of 0.1%, 0.6%, 1.2%, 1.8%, 2.4%, 3%, 3.6%, 4.2%, 4.8%, or 5%.

In some embodiments, the transmittance of the polarizing film 100 for S-polarized light is at least one of 0.1%-1.2%, 0.1%-2.4%, 0.6%-2.4%, 1.2%-3.6%, 1.2%-4.2%, 2.4%-5%, or 4.2%-5%.

In some embodiments, a transmittance of the polarizing film 100 for S-polarized light is at least one of 60%-100%.

In some embodiments, the polarizing film 100 may have a transmittance for P-polarized light of at least one of 60%, 65%, 70%, 75%, 80%, 85%, 90%, 95%, or 100%.

In some embodiments, the transmittance of the polarizing film 100 for P-polarized light is at least one of 60%-80%, 70%-80%, 75%-85%, 85%-95%, 80%-100%, or 90%-100%.

In some embodiments, the transmittance of the polarizing film 100 for the S-polarized light, and the transmittance of the polarizing film 100 for the S-polarized light may also be determined based on actual application scenarios and needs.

In some embodiments of the present disclosure, the polarizing film 100 has a very low transmittance rate for S-polarized light, so that the front projection light cannot be received through the polarizing film 100; and it has a higher transmittance rate for P-polarized light, so that P-polarized light in the ambient light can be received by an observer through the polarizing film 100, thus not affecting the observation of real space of the observer.

In some embodiments, the distance between the optical waveguide 210 and the polarizing film 100 (i.e., the width of the gap between the optical waveguide 210 and the polarizing film 100) is in a range of 1 μm-5 cm.

In some embodiments, the distance between the optical waveguide 210 and the polarizing film 100 may be at least one of 1 μm, 5000 μm, 1 cm, 1.5 cm, 2 cm, 2.5 cm, 3 cm, 3.5 cm, 4 cm, 4.5 cm, or 5 cm.

In some embodiments, the distance between the optical waveguide 210 and the polarizing film 100 may be at least one of 1 μm-2.5 cm, 1 μm-1.5 cm, 5000 μm-4.5 cm, 1 cm-2.5 cm, 1.5 cm-3.5 cm, 2.5 cm-4 cm, 2.5 cm-5 cm, or 3.5 cm-5 cm.

According to some embodiments of the present disclosure, by setting the distance between the optical waveguide and the polarizing film, it can be ensured that the polarizing film 100 does not affect the optical waveguide 210 imaging, which in turn can ensure the final imaging effect.

In some embodiments, the polarizing film 100 is secured to the optical waveguide 210 by a bonding adhesive 240, the bonding adhesive is disposed at an edge position of the polarizing film 100 and the optical waveguide 210.

In some embodiments, the type of bonding adhesive 240 includes but is not limited to, optically clear adhesive (OCA).

In some embodiments, the type of bonding adhesive 240 may also be determined based on actual application scenarios and needs.

In some embodiments, the optical waveguide lens further includes a rigid substrate (not shown) for supporting the polarizing film 100, the rigid substrate is affixed to a side of the polarizing film 100 away from the optical waveguide 210.

According to some embodiments of the present disclosure, the rigid substrate may support the polarizing film 100, providing a rigid support effect for the polarizing film 100, and avoiding the polarizing film 100 from completely fitting onto the optical waveguide 210, which may affect the imaging effect.

According to some embodiments of the present disclosure, the optical waveguide lens 200 is capable of avoiding frontal projection, which improves display privacy and facilitates a wide range of applications.

According to some embodiments of the present disclosure, it has been experimentally verified that the above-described polarizing film is capable of combining the optical properties of a low absorption loss, a high extinction ratio, and a wide incident angle, thereby enhancing the performance of the display device employing the above-described polarizing film, making the above-described display device conducive to a wide range of applications.

Referring to the above embodiments, in order to make the technical solutions of the present disclosure more specific and clear, and easy to understand, embodiments of the technical solutions of the present disclosure are now given, but it is to be noted that the contents to be protected by the present disclosure are not limited to the following embodiments 1-33.

### Embodiments 1-33

The structures of the polarizing film 100 of embodiment 1-embodiment 33 are as in FIG. 2, and the relevant structural parameters are shown in Table 1. In the polarizing film 100 of embodiment 1, the transparent substrate 110 is made of polycarbonate (PC), the dielectric grating 121 is made of UV adhesive, the metallic layer 122 is all made of aluminum, and the protective layer 130 is made of SiO₂.

The polarizing film of embodiment 1 is produced as follows:
Providing transparent substrates and transparent substrates;
Coating an imprinting adhesive on the transparent substrate, bonding transparent substrate with the imprinting template, extruding the transparent substrate and the imprinting template by a roller, and then performing UV irradiation on the imprinting adhesive. After the imprinting adhesive is cured, the transparent substrate was removed, and the imprinting template was demolded from the cured adhesive, i.e., a dielectric grating was formed on the transparent substrate at intervals along a direction parallel to the surface of the transparent substrate;
Using high-temperature adhesive tape to attach the transparent substrate and the dielectric grating to the fixture, and then putting them into the coating equipment together, and evacuating the vacuum, setting the process coating parameters as follows: the coating rate of 10 A/S, the evaporation power of 60%, and the operating vacuum of 5E-6Torr, the temperature is 30° C. After the coating is completed, the metallic layer precursor was formed on the dielectric grating; the metallic layer precursor on the side of the dielectric grating away from the transparent substrate was removed by a polishing process. The metallic layer precursor on the side of the dielectric grating away from the transparent substrate was polished using chemical-mechanical polishing (CMP). The polishing parameters are as follows: the film layer is Al, the film thickness is 150 nm, the grinding duration is 30 min, the choice of polishing solution for aluminum, polishing disc speed is 40 r/min, the sample speed is 60 r/min, homogeneity <5%, surface roughness is 5 nm.

Subsequently, coating the protective layer by thermal evaporation, with the following coating parameters: coating rate of 5A/S, operating vacuum: 5E-6Torr, and coating time 30 min.

The polarizing film 100 of embodiment 2-embodiment 33 was obtained by 3D structural model fitting.

TABLE 1
Table of structural parameters of the polarizing film of embodiments 1-33

| | | | Grating layer | | | | | | |
|---|---|---|---|---|---|---|---|---|---|
| | | | | | | | Metallic | | |
| | Transparent substrate | | Dielectric grating | | | | layer | Protective layer | |
| | Refractive | Thickness | Period | Duty | Thickness | Refractive | Thickness | Refractive | Thickness |
| | index | h1 | p | cycle | h2 | index | h2 | index | h3 |
| Embodiment | N1 | (μm) | (nm) | f | (nm) | N2 | (nm) | N3 | (nm) |
| Embodiment | 1.6 | 100 | 100 | 0.5 | 130 | 1.48 | 130 | 1.5 | 100 |
| 1 | | | | | | | | | |
| Embodiment | 1.4 | 100 | 100 | 0.5 | 130 | 1.48 | 130 | 1.5 | 100 |
| 2 | | | | | | | | | |
| Embodiment | 1.55 | 100 | 100 | 0.5 | 130 | 1.48 | 130 | 1.5 | 100 |
| 3 | | | | | | | | | |
| Embodiment | 1.7 | 100 | 100 | 0.5 | 130 | 1.48 | 130 | 1.5 | 100 |
| 4 | | | | | | | | | |
| Embodiment | 1.85 | 100 | 100 | 0.5 | 130 | 1.48 | 130 | 1.5 | 100 |
| 5 | | | | | | | | | |
| Embodiment | 2 | 100 | 100 | 0.5 | 130 | 1.48 | 130 | 1.5 | 100 |
| 6 | | | | | | | | | |
| Embodiment | 1.6 | 100 | 100 | 0.5 | 130 | 1.4 | 130 | 1.5 | 100 |
| 7 | | | | | | | | | |
| Embodiment | 1.6 | 100 | 100 | 0.5 | 130 | 1.55 | 130 | 1.5 | 100 |
| 8 | | | | | | | | | |
| Embodiment | 1.6 | 100 | 100 | 0.5 | 130 | 1.7 | 130 | 1.5 | 100 |
| 9 | | | | | | | | | |
| Embodiment | 1.6 | 100 | 100 | 0.5 | 130 | 1.85 | 130 | 1.5 | 100 |
| 10 | | | | | | | | | |
| Embodiment | 1.6 | 100 | 100 | 0.5 | 130 | 2 | 130 | 1.5 | 100 |
| 11 | | | | | | | | | |
| Embodiment | 1.6 | 100 | 100 | 0.5 | 130 | 1.48 | 130 | 1.3 | 100 |
| 12 | | | | | | | | | |
| Embodiment | 1.6 | 100 | 100 | 0.5 | 130 | 1.48 | 130 | 1.425 | 100 |
| 13 | | | | | | | | | |
| Embodiment | 1.6 | 100 | 100 | 0.5 | 130 | 1.48 | 130 | 1.55 | 100 |
| 14 | | | | | | | | | |
| Embodiment | 1.6 | 100 | 100 | 0.5 | 130 | 1.48 | 130 | 1.675 | 100 |
| 15 | | | | | | | | | |
| Embodiment | 1.6 | 100 | 100 | 0.5 | 130 | 1.48 | 130 | 1.8 | 100 |
| 16 | | | | | | | | | |
| Embodiment | 1.6 | 100 | 50 | 0.5 | 130 | 1.48 | 130 | 1.5 | 100 |
| 17 | | | | | | | | | |
| Embodiment | 1.6 | 100 | 75 | 0.5 | 130 | 1.48 | 130 | 1.5 | 100 |
| 18 | | | | | | | | | |
| Embodiment | 1.6 | 100 | 125 | 0.5 | 130 | 1.48 | 130 | 1.5 | 100 |
| 19 | | | | | | | | | |
| Embodiment | 1.6 | 100 | 150 | 0.5 | 130 | 1.48 | 130 | 1.5 | 100 |
| 20 | | | | | | | | | |
| Embodiment | 1.6 | 100 | 100 | 0.25 | 130 | 1.48 | 130 | 1.5 | 100 |
| 21 | | | | | | | | | |
| Embodiment | 1.6 | 100 | 100 | 0.375 | 130 | 1.48 | 130 | 1.5 | 100 |
| 22 | | | | | | | | | |
| Embodiment | 1.6 | 100 | 100 | 0.625 | 130 | 1.48 | 130 | 1.5 | 100 |
| 23 | | | | | | | | | |
| Embodiment | 1.6 | 100 | 100 | 0.75 | 130 | 1.48 | 130 | 1.5 | 100 |
| 24 | | | | | | | | | |
| Embodiment | 1.6 | 100 | 100 | 0.5 | 60 | 1.48 | 60 | 1.5 | 100 |
| 25 | | | | | | | | | |
| Embodiment | 1.6 | 100 | 100 | 0.5 | 95 | 1.48 | 95 | 1.5 | 100 |
| 26 | | | | | | | | | |
| Embodiment | 1.6 | 100 | 100 | 0.5 | 165 | 1.48 | 165 | 1.5 | 100 |
| 27 | | | | | | | | | |
| Embodiment | 1.6 | 100 | 100 | 0.5 | 200 | 1.48 | 200 | 1.5 | 100 |
| 28 | | | | | | | | | |
| Embodiment | 1.6 | 100 | 100 | 0.5 | 130 | 1.48 | 130 | 1.5 | 50 |
| 29 | | | | | | | | | |
| Embodiment | 1.6 | 100 | 100 | 0.5 | 130 | 1.48 | 130 | 1.5 | 87.5 |
| 30 | | | | | | | | | |
| Embodiment | 1.6 | 100 | 100 | 0.5 | 130 | 1.48 | 130 | 1.5 | 125 |
| 31 | | | | | | | | | |
| Embodiment | 1.6 | 100 | 100 | 0.5 | 130 | 1.48 | 130 | 1.5 | 162.6 |
| 32 | | | | | | | | | |
| Embodiment | 1.6 | 100 | 100 | 0.5 | 130 | 1.48 | 130 | 1.5 | 200 |
| 33 | | | | | | | | | |

### Performance Test

### (1) Transmittance

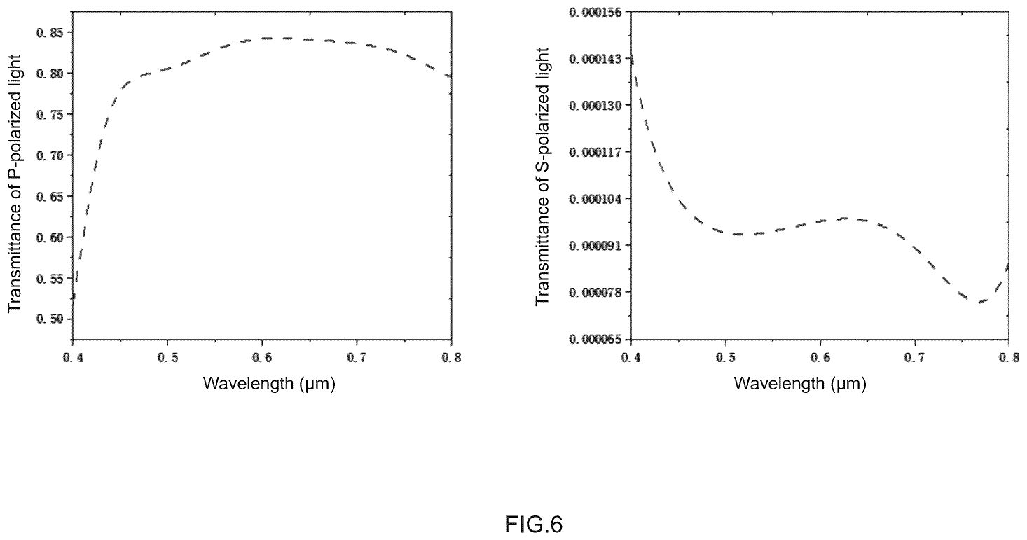

The polarizing film 100 of embodiment 1 is brought into a 3D structural model (hereinafter referred to as the “model”) and the parameters are calibrated, and then the transmittance of the P-polarized light and the S-polarized light at positive incidence is calculated based on the simulation of the rigorous coupled wave theory as shown in FIG. 6. From FIG. 6, it may be seen that the transmittance of P-polarized light in the 400 nm-800 nm band is 70% on average, with the highest point at 80%; and the transmittance of S-polarized light in the 400 nm-800 nm band is 0.28% on average.

By calculating Tp and Tc at wavelengths of 450 nm, 550 nm, and 650 nm, the corresponding values of extinction ratios may be calculated, as shown in Table 2. From the data in Table 2, it may be seen that the extinction ratio of the polarizing film 100 of embodiment 1 is 38.91 dB at a wavelength of 450 nm, 39.64 dB at a wavelength of 550 nm, and 39.25 dB at a wavelength of 650 nm. The above experimental data indicate that the polarizing film 100 of embodiment 1 has a relatively low absorption loss and a relatively high extinction ratio.

TABLE 2
Table of test data of the polarizing film 100 of embodiment 1

| Wavelength | 450 nm | 550 nm | 650 nm |
|---|---|---|---|
| Transmittance Tp | 77.86% | 82.84% | 84.14% |
| Transmittance Tc | 0.01% | 0.009% | 0.01% |
| EXT | 38.91 dB | 39.64 dB | 39.25 dB |

### (2) Change in Incident Angle

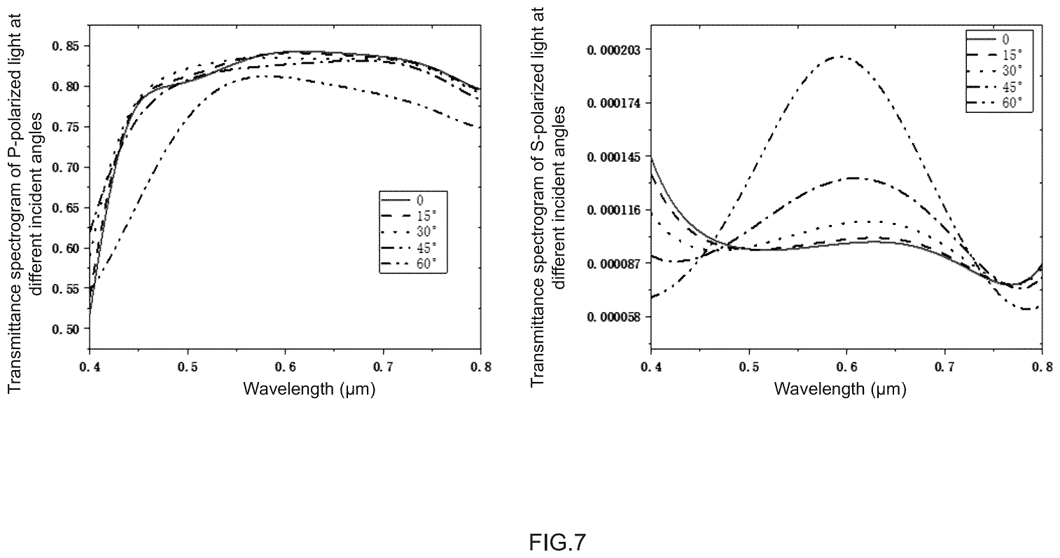

The polarizing film 100 of embodiment 1 was irradiated at different incident angles) (0-60°, and the transmittance spectrogram of P-polarized light and S-polarized light at different incident angles were obtained, as shown in FIG. 7. As may be seen from FIG. 7, when the incident angle is changed from 0-60°, there is not much effect on the transmittance spectrogram of P-polarized light and S-polarized light in the range of the visible wavelength band, which indicates that the polarizing film designed in this application has a large angular tolerance, which is very suitable for large-angle application scenarios.

The foregoing demonstrates that the polarizing film 100 of embodiment 1 is suitable for a wide range of incident angles.

### (3) Reflectance

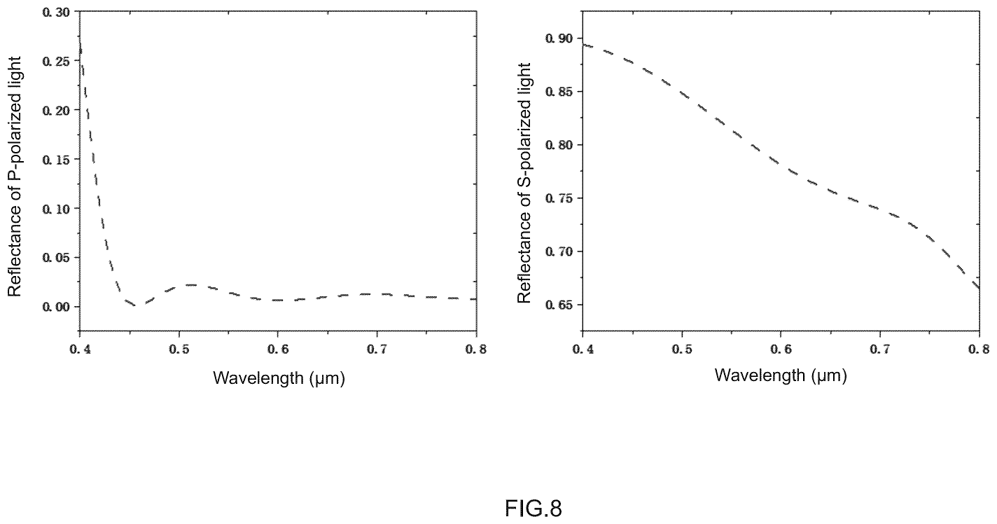

The polarizing film 100 of embodiment 1 was brought into the model for simulation to calculate the reflectance of the P-polarized light and the S-polarized light, as shown in FIG. 8. From FIG. 8, it may be seen that the reflectance of the P-polarized light in the 400 nm-800 nm band is at 2% on average; the reflectance of the S-polarized light in the 400 nm-800 nm band is at 80% on average, and the highest reflectance is 88%. This indicates that the polarizing film 100 of embodiment 1 has a low absorption loss and a high extinction ratio.

### (4) Change in Refractive Index N1 of Transparent Substrate

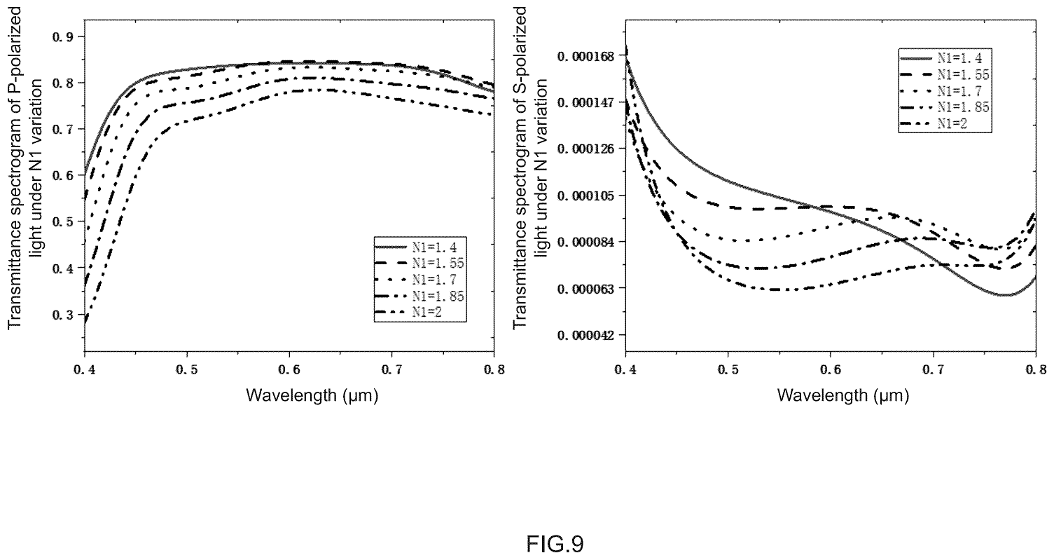

The polarizing film 100 of embodiments 2-6 was brought into the model for simulation, and the transmittance spectrogram of the P-polarized light and S-polarized light in the visible band at 0 degree of incidence were obtained, as shown in FIG. 9. From FIG. 9, it may be seen that when the N1 refractive index is varied in the range of 1.4-2, it does not have much effect on the transmittance spectrogram of the P-polarized light and S-polarized light in the visible band range.

### (5) Change in Refractive Index N2 of Dielectric Grating

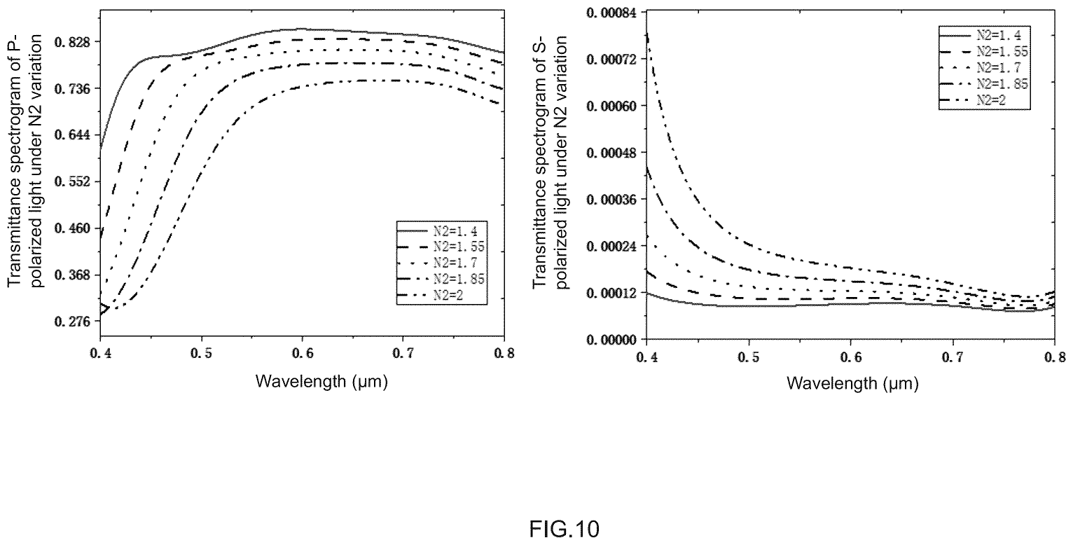

The polarizing film 100 of embodiments 7-11 was brought into the model for simulation, and the P-polarized light and S-polarized light visible band transmittance spectrogram were obtained for 0 degree incidence, as shown in FIG. 10. From FIG. 10, it may be seen that the transmittance spectrogram of the P-polarized light in the visible wavelength range is not much affected when the N2 refractive index varies in the range of 1.4-2; the transmittance of the S-polarized light in the visible wavelength range changes gently with the increase of refractive index, and the overall magnitude does not change much.

### (6) Change in Refractive Index N3 of the Protective Layer

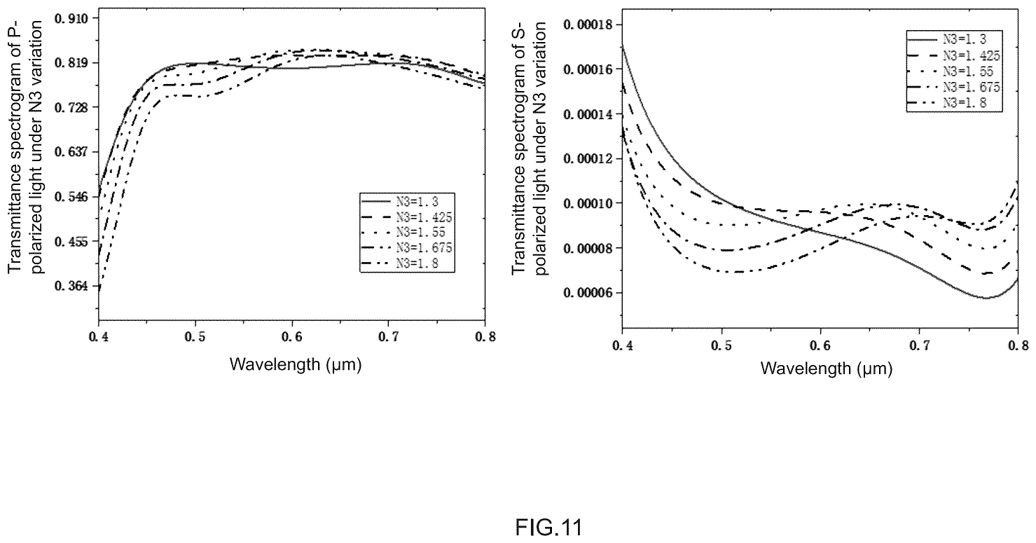

The polarizing film 100 of embodiments 12-16 was brought into the model for simulation, and the transmittance spectrogram of the visible band of P-polarized light and S-polarized light at 0 degree of incidence were obtained, as shown in FIG. 11. From FIG. 11, it may be seen that when the N3 refractive index is varied between 1.3-1.8, the transmittance spectrogram of the P-polarized light in the visible wavelength range are not much affected, and the transmittance spectrogram of the S-polarized light in the visible wavelength range change gently with the increase of refractive index, and the overall amplitude does not change much.

By calculating Tp and Tc at wavelengths of 450 nm, 550 nm, and 650 nm of the polarizing film 100 of embodiment 15, the corresponding values of the extinction ratios may be calculated, as shown in Table 3. From the data in Table 3, it may be seen that the polarizing film 100 of embodiment 15 has a lower absorption loss and a higher extinction ratio.

TABLE 3
Table of test data for the polarizing film 100 of embodiment 15

| Wavelength | 450 nm | 550 nm | 650 nm |
|---|---|---|---|
| Transmittance Tp | 75.06% | 80.61% | 84.21% |
| Transmittance Tc | 0.0088% | 0.0082% | 0.0098% |
| Extinction ratio EXT | 39.31 dB | 39.92 dB | 39.34 dB |

### (7) Change in the Period P of the Dielectric Grating

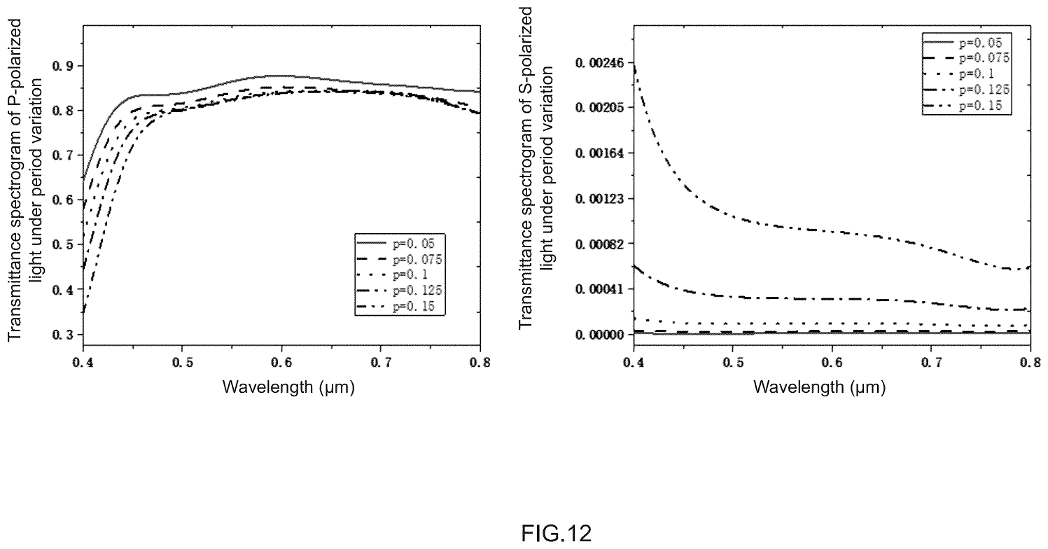

The polarizing film 100 of embodiments 1 and 17-20 was brought into the model for simulation, and the transmittance spectrogram of P-polarized light and S-polarized light in the visible band at 0 degree of incidence were obtained, as shown in FIG. 12. From FIG. 12, it can be seen that the transmittance of P-polarized light in the visible wavelength range gradually decreases when the period p varies from 50 nm to 150 nm, with a limited decrease; the transmittance of S-polarized light in the visible wavelength range increases with the period p, but the increase is not significant.

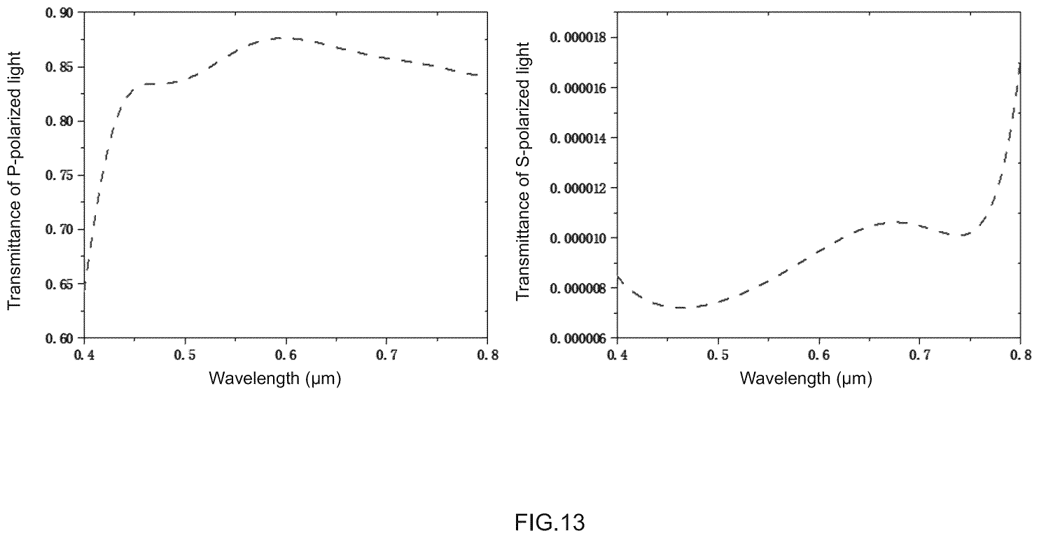

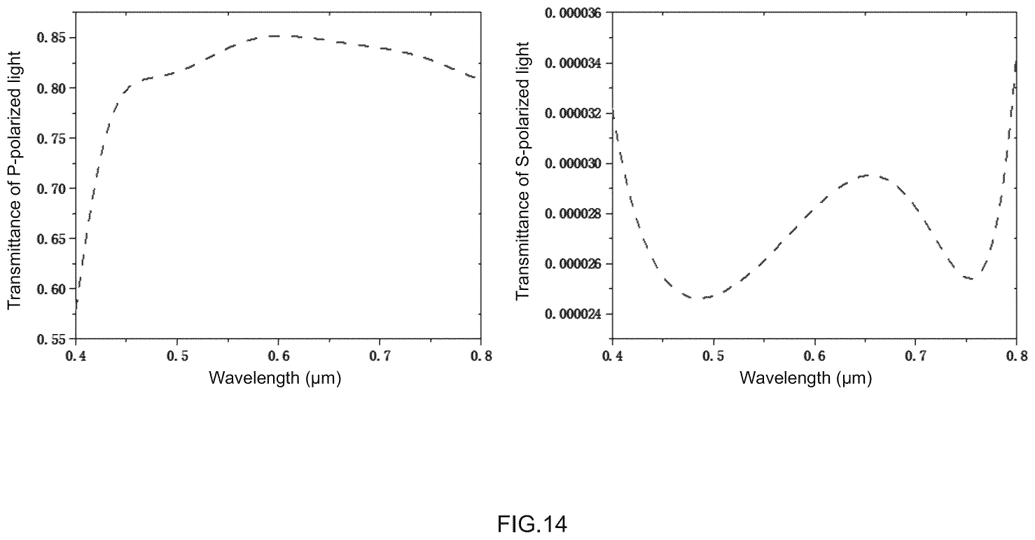

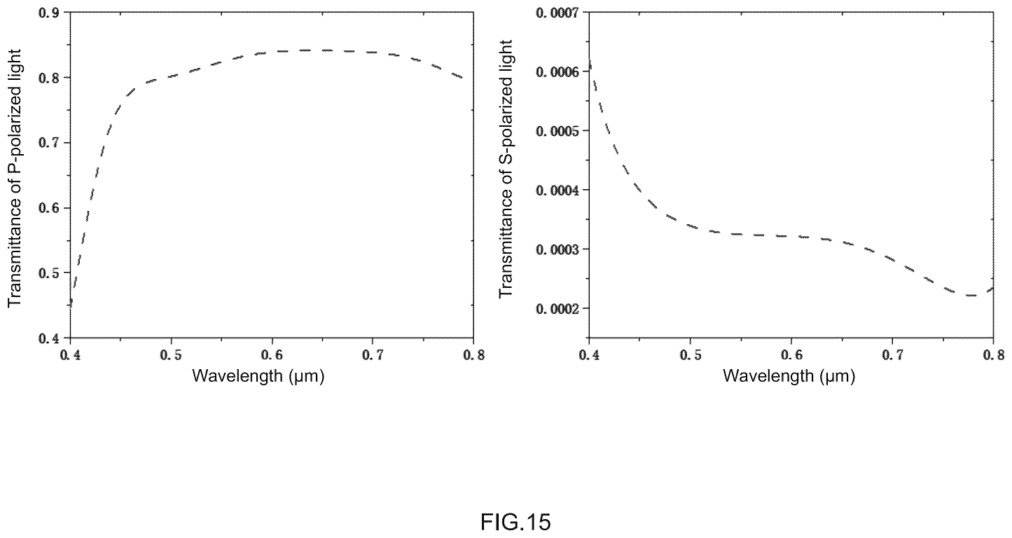

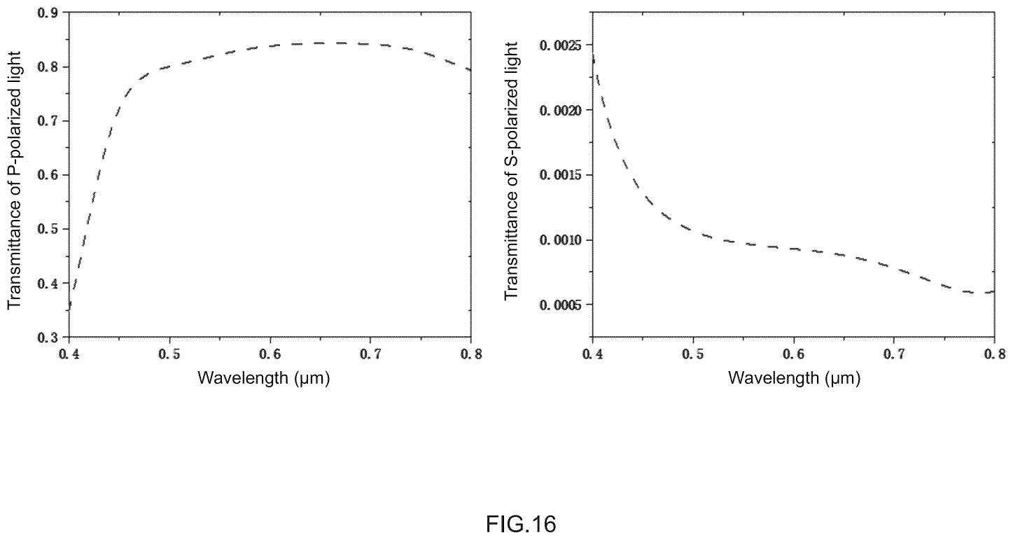

The polarizing film 100 of embodiments 17-20 was brought into the model for simulation to calculate the transmittance of the P-polarized light and the S-polarized light under normal incidence, as shown in FIGS. 13-16. From FIGS. 13-16, it may be seen that the average transmittance of the P-polarized light is higher in the 400 nm-800 nm band; and the average transmittance of the S-polarized light is lower in the 400 nm-800 nm band. It is shown that the polarizing film 100 of embodiments 17-20 has a lower absorption loss.

The Tp and Tc at wavelengths 450 nm, 550 nm, and 650 nm of the polarizing film 100 of embodiments 17-20, and the calculated values of extinction ratios, are shown in Table 4. From the data in Table 4, it may be seen that the polarizing film 100 of embodiments 17-20 has a high extinction ratio.

TABLE 4
Table of test data for polarizing film 100 of embodiments 17-20

| Embodiment | Wavelength | 450 nm | 550 nm | 650 nm |
|---|---|---|---|---|
| Embodiment | Transmittance Tp | 82.96% | 86.42% | 86.78% |
| 17 | Transmittance Tc | 0.00072% | 0.00083% | 0.001% |
| | Extinction ratio | 50.61 dB | 50.17 dB | 49.38 dB |
| | EXT | | | |
| Embodiment | Transmittance Tp | 79.83% | 83.97% | 84.7% |
| 18 | Transmittance Tc | 0.0025% | 0.0026% | 0.0029% |
| | Extinction ratio | 45.04 dB | 45.09 dB | 44.65 dB |
| | EXT | | | |
| Embodiment | Transmittance Tp | 75.83% | 82.41% | 84.15% |
| 19 | Transmittance Tc | 0.0399% | 0.0325% | 0.0312% |
| | Extinction ratio | 32.79 dB | 34.04 dB | 34.31 dB |
| | EXT | | | |
| Embodiment | Transmittance Tp | 72.2% | 82.22% | 84.28% |
| 20 | Transmittance Tc | 0.13% | 0.097% | 0.088% |
| | Extinction ratio | 27.45 dB | 29.28 dB | 29.81 dB |
| | EXT | | | |

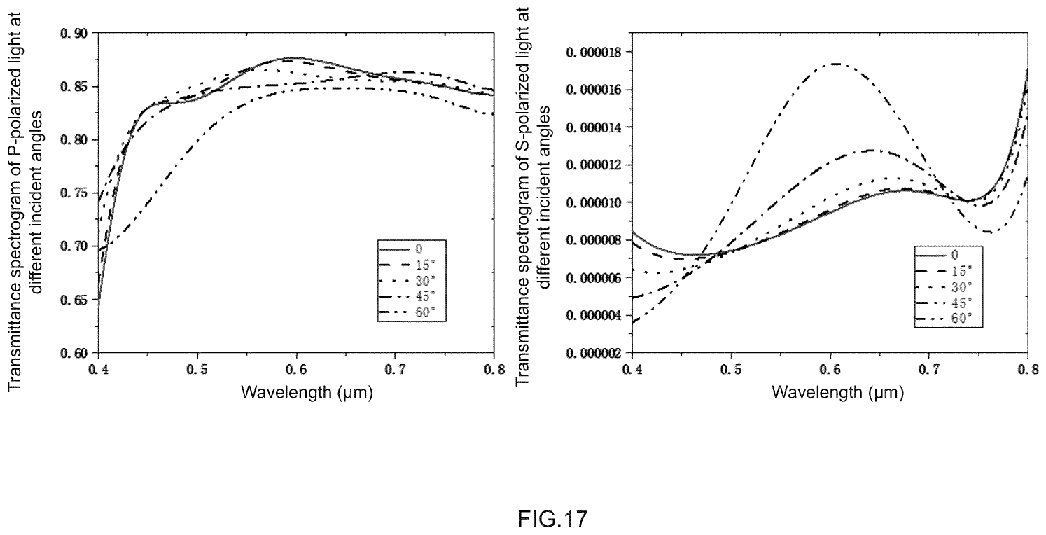

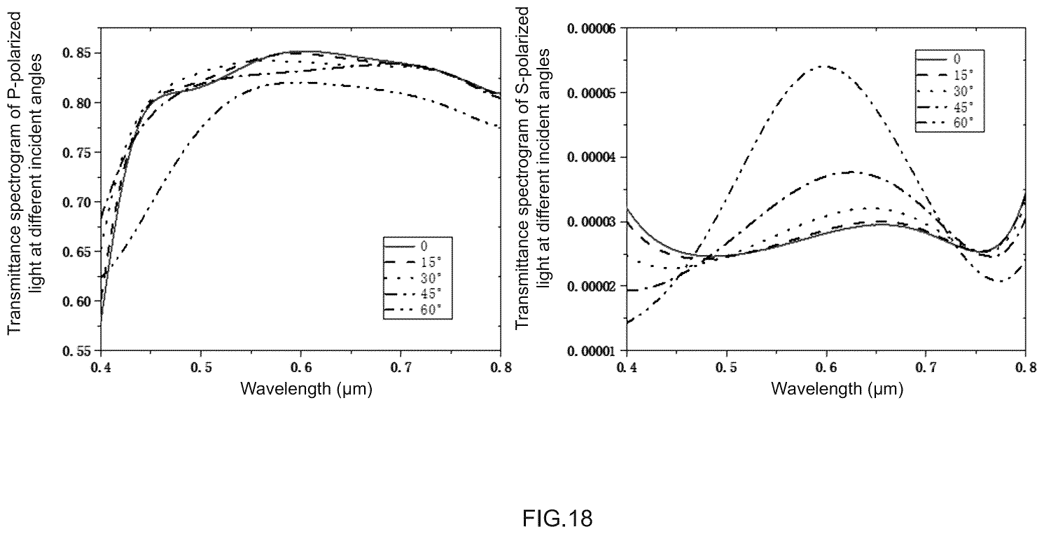

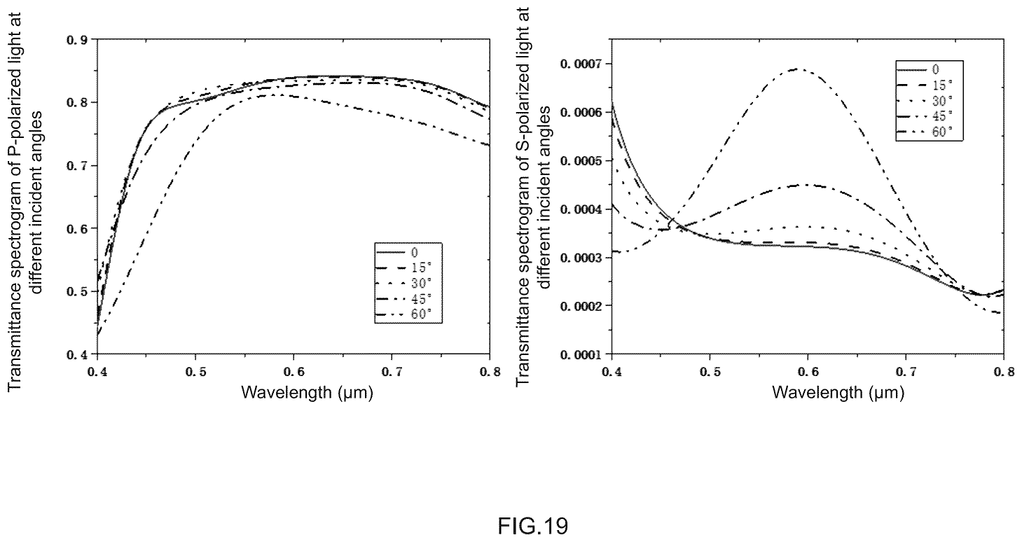

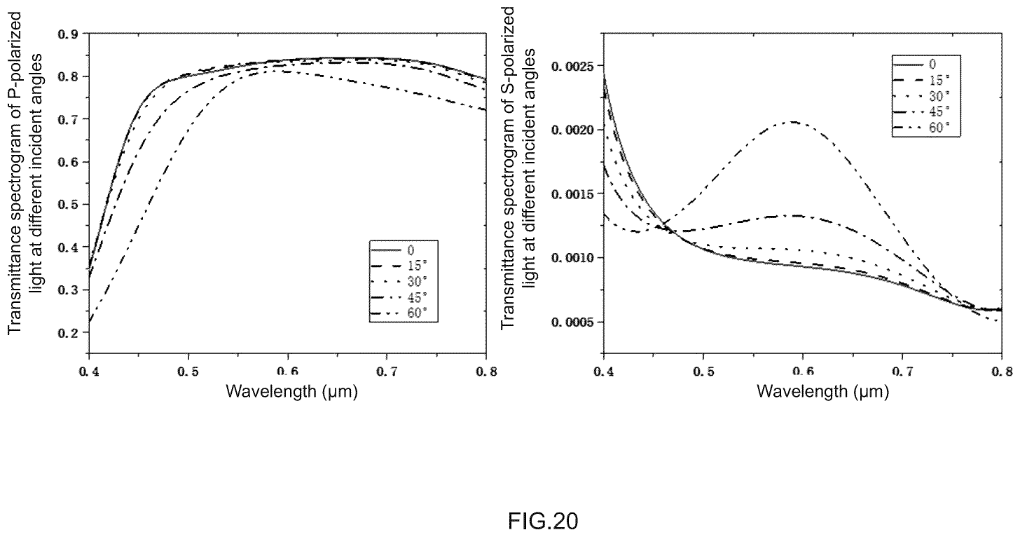

The polarizing film 100 of embodiments 17-20 was irradiated at different incident angles) (0-60° to obtain transmittance spectrogram of P-polarized light and S-polarized light at different incident angles, as shown in FIGS. 17-20. As may be seen from FIGS. 17-20, there is little effect on the transmittance spectrogram of P-polarized light and S-polarized light in the visible wavelength range as the incident angle varies from 0-60°, suggesting that the polarizing film 100 of embodiments 17-20 is suitable for a wider incident angle.

### (8) Change in Duty Cycle F of Dielectric Grating

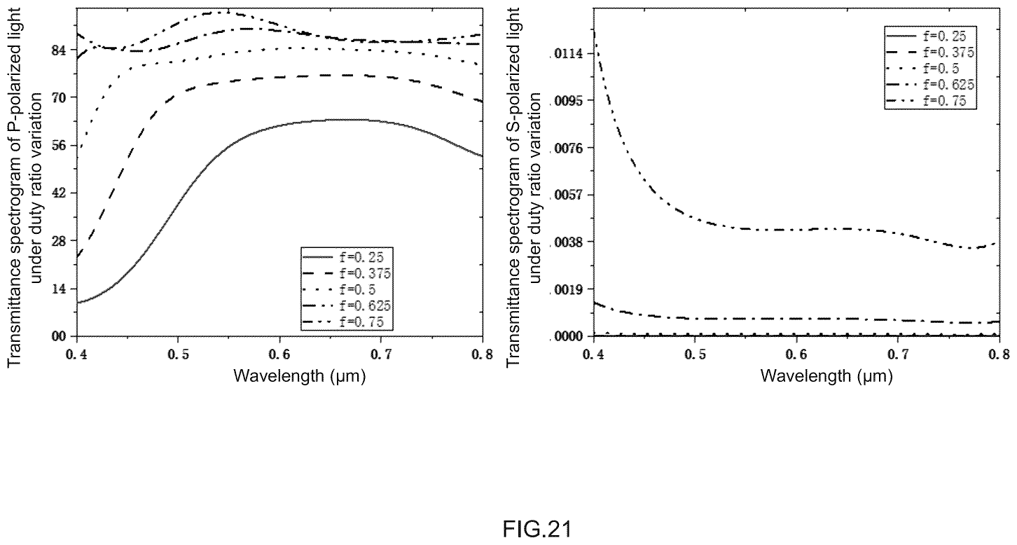

The polarizing film 100 of embodiments 1 and 21-24 was brought into the model for simulation, and the transmittance spectrogram of the P-polarized light and S-polarized light in the visible band at 0 degree of incidence were obtained, as shown in FIG. 21. From FIG. 21, it may be seen that the transmittance of the P-polarized light in the visible wavelength range gradually increases when the duty cycle f is varied in the range of 0.25-0.75; the transmittance of the S-polarized light in the visible wavelength range increases as the duty cycle f increases.

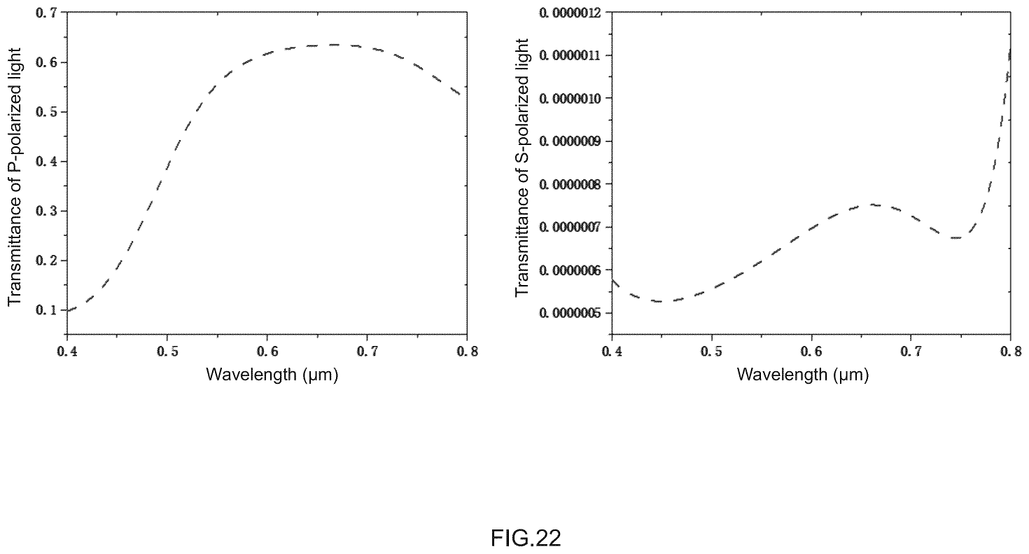

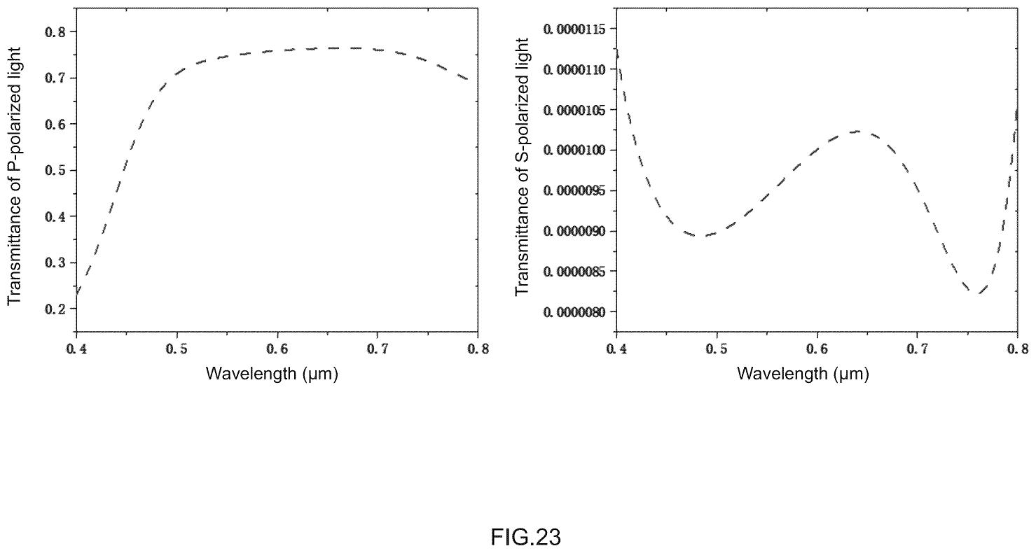

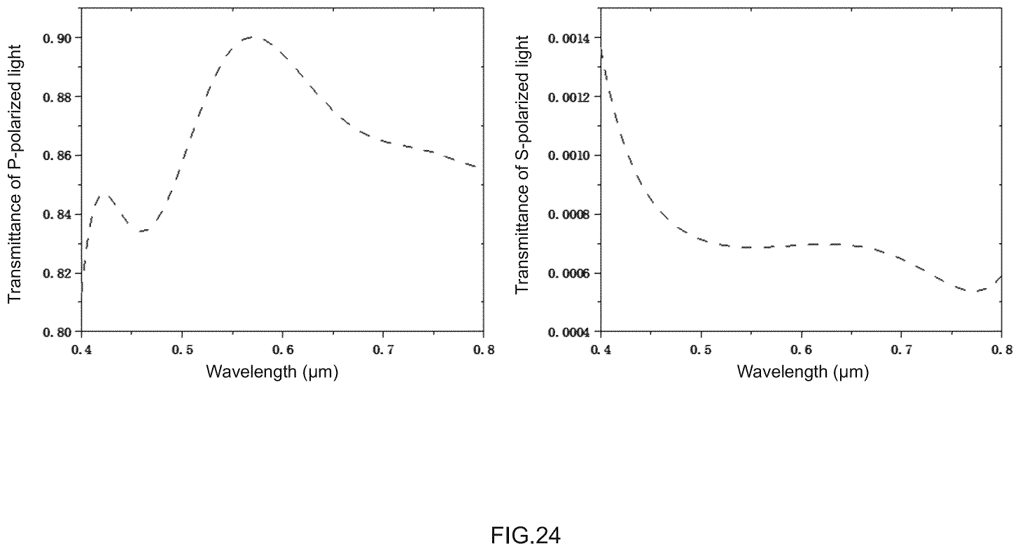

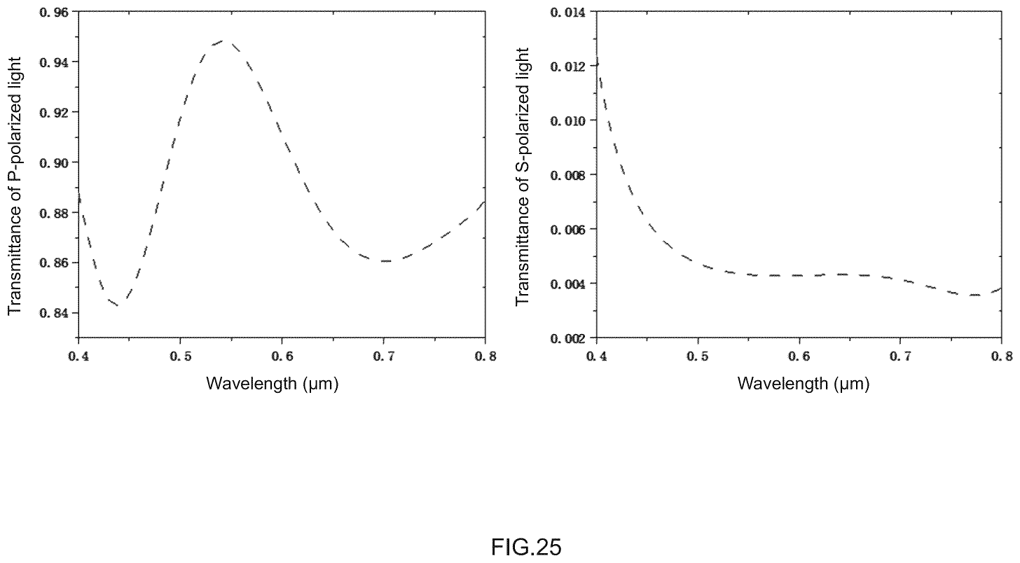

The polarizing film 100 of embodiments 21-24 was brought into the model for simulation to calculate the transmittance of the P-polarized light and the S-polarized light at positive incidence, in turn, as shown in FIGS. 22-25. From FIGS. 22-25, it may be seen that the average transmittance of the P-polarized light is relatively high in the 400 nm-800 nm band; and the average transmittance of the S-polarized light is relatively low in the 400 nm-800 nm band. It is shown that the polarizing film 100 of embodiments 21-24 has a relatively low absorption loss.

The Tp and Tc at wavelengths of 450 nm, 550 nm, and 650 nm of the polarizing film 100 of embodiments 21-24, and the calculated values of extinction ratios, are shown in Table 5. From the data in Table 5, it may be seen that the polarizing film 100 of embodiments 21-24 has a high extinction ratio.

TABLE 5
Table of test data for polarizing film 100 of embodiments 21-24

| Embodi- | | | | |
|---|---|---|---|---|
| ment | Wavelength | 450 nm | 550 nm | 650 nm |
| Embodi- | Transmittance Tp | 18.47% | 55.5% | 63.36% |
| ment 21 | Transmittance Tc | 0.00005% | 0.00006% | 0.00007% |
| | Extinction ratio | 55.67 dB | 59.6 dB | 59.56 dB |
| | EXT | | | |
| Embodi- | Transmittance Tp | 51.76% | 74.64% | 76.41% |
| ment 22 | Transmittance Tc | 0.0009% | 0.00094% | 0.001% |
| | Extinction ratio | dB | 51.20 dB | 50.91 dB |
| | EXT | | | |
| Embodi- | Transmittance Tp | 83.55% | 89.64% | 87.53% |
| ment 23 | Transmittance Tc | 0.085% | 0.068% | 0.069% |
| | Extinction ratio | 29.92 dB | 31.2 dB | 31.03 dB |
| | EXT | | | |
| Embodi- | Transmittance Tp | 84.76% | 94.72% | 87.31% |
| ment 24 | Transmittance Tc | 0.63% | 0.43% | 0.43% |
| | Extinction ratio | 21.29 dB | 23.43 dB | 23.08 dB |
| | EXT | | | |

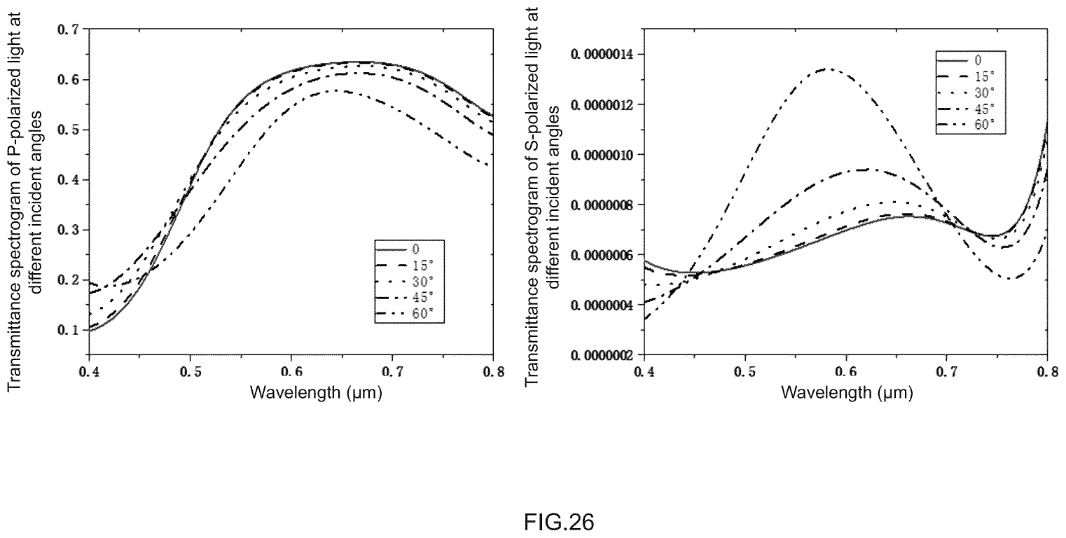

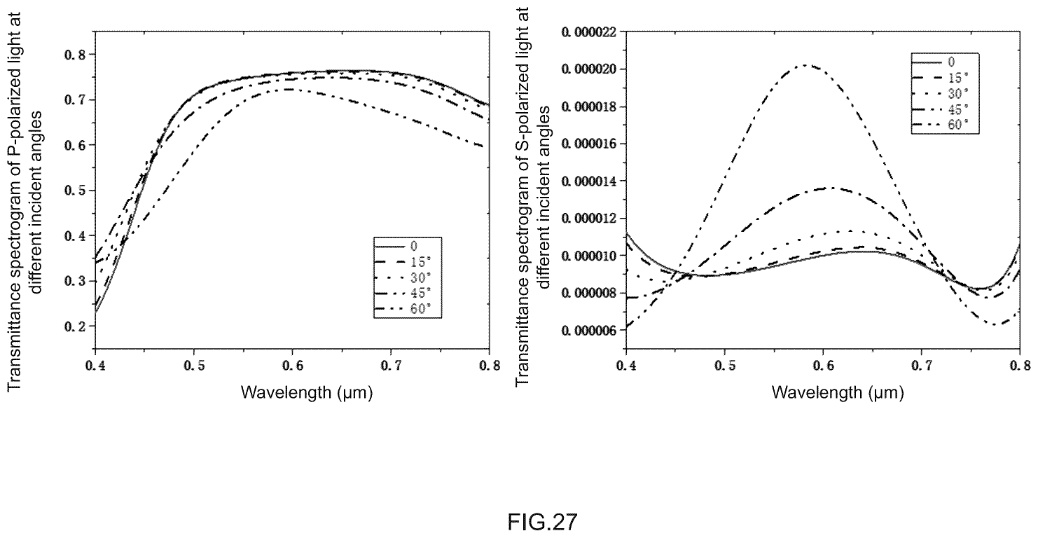

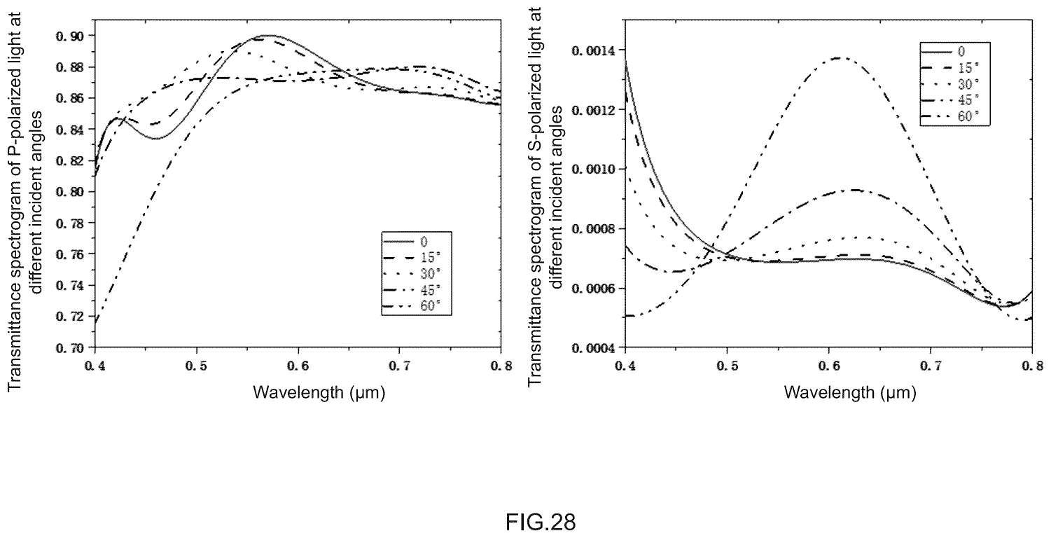

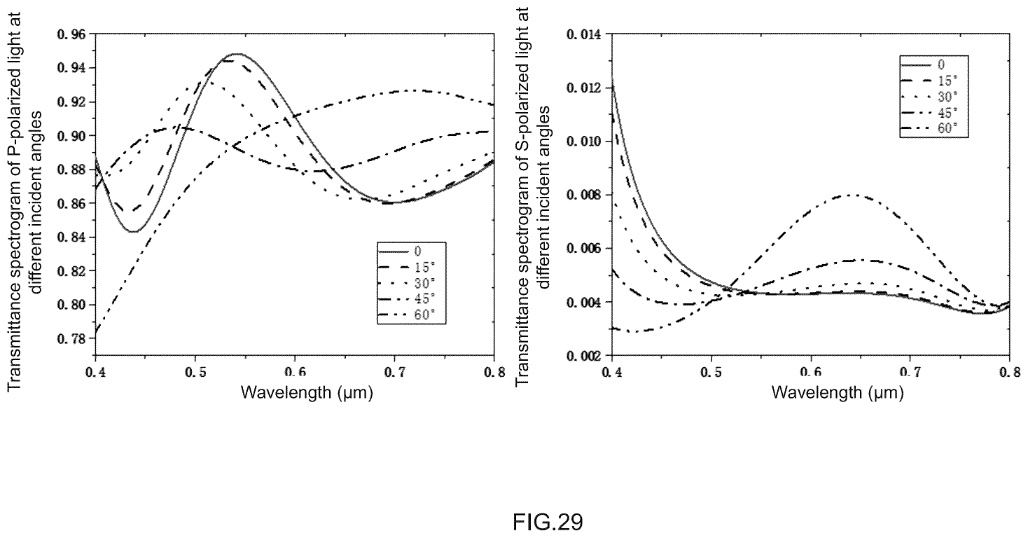

The polarizing film 100 of embodiments 21-24 was irradiated at different incident angles) (0-60° to obtain transmittance spectrogram of the P-polarized light and the S-polarized light at different incident angles, as shown in FIGS. 26-29. As may be seen from FIGS. 26-29, there is little effect on the transmittance spectrogram of the P-polarized light and the S-polarized light in the visible wavelength range when the incident angle is varied from 0-60°, suggesting that the polarizing film 100 of embodiments 21-24 is suitable for a wider incident angle.

### (9) Variation of Ridge Thickness H2 of the Dielectric Grating

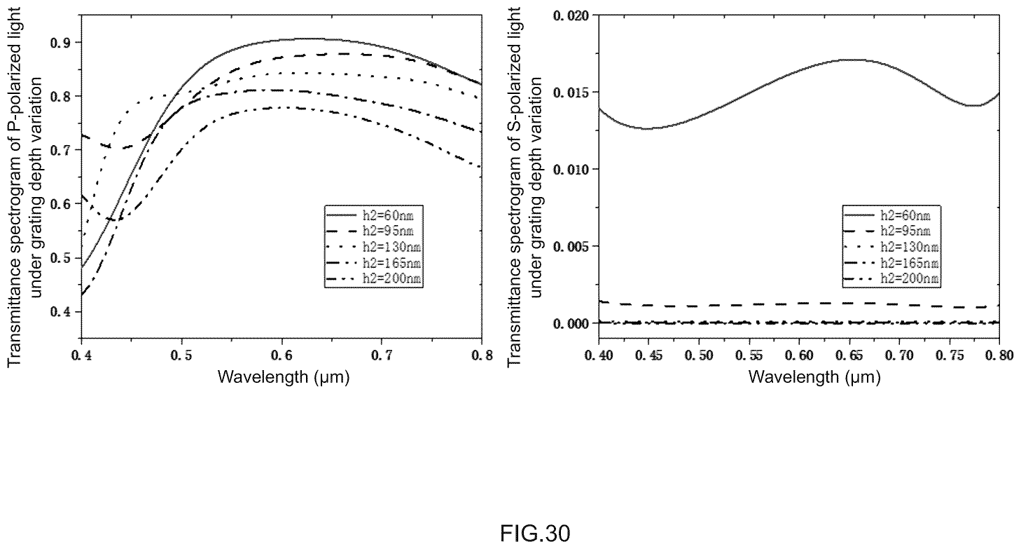

The polarizing film 100 of embodiments 1 and 25-28 was brought into the model for simulation to obtain the spectral effect of the transmittance rate of the P-polarized light and the S-polarized light in the visible band at 0 degree of incidence, as shown in FIG. 30. From FIG. 30, it can be seen that when the thickness h2 of the ridge of the dielectric grating is varied between 60 nm and 200 nm, the transmittance change of the P-polarized light in the visible wavelength range is limited; the transmittance of the S-polarized light in the visible wavelength range decreases significantly with the increase of depth h1, and the decrease is obvious.

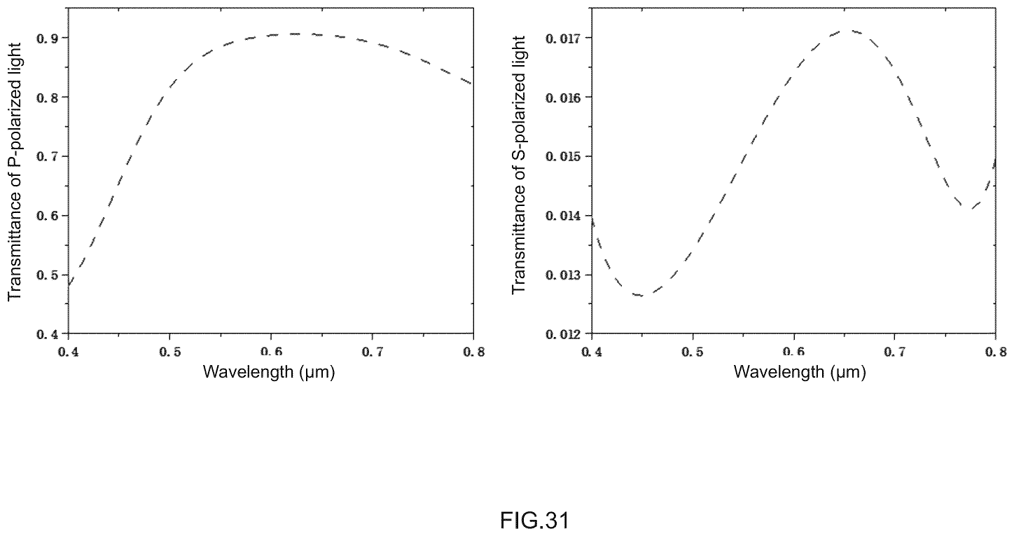

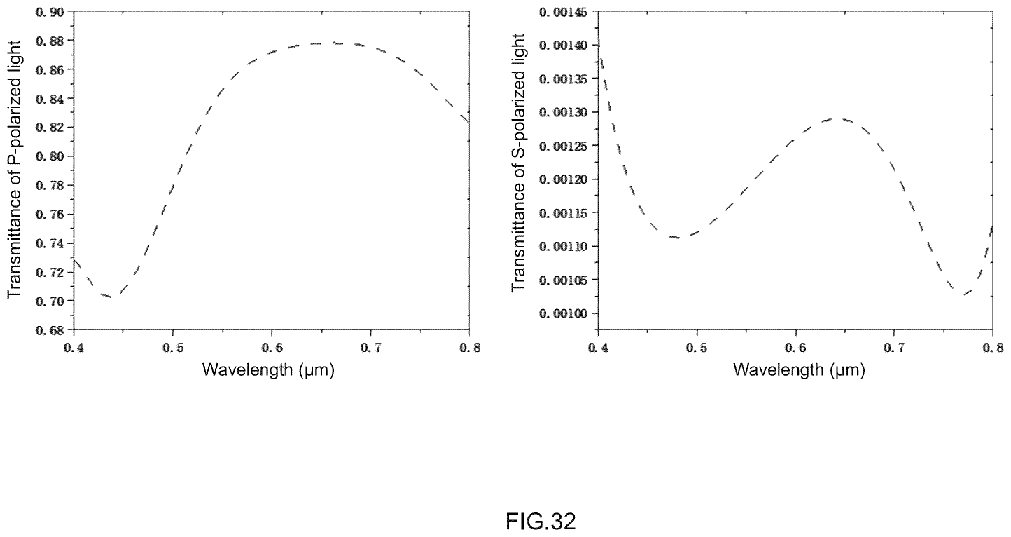

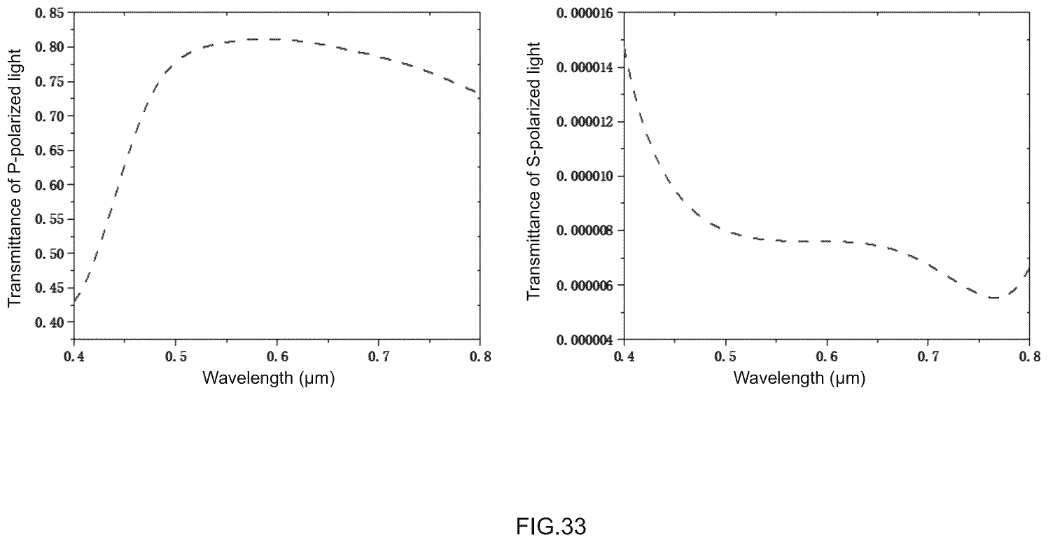

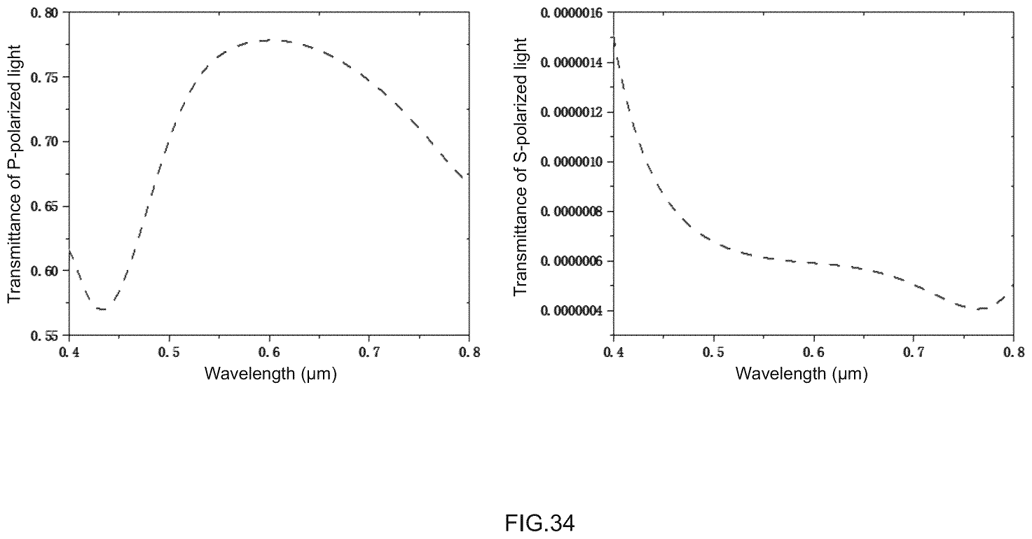

The polarizing film 100 of embodiments 25-28 was brought into the model for simulation to calculate the transmittance of the P-polarized light and the S-polarized light when they were positively incident, in order as shown in FIGS. 31-34. From FIGS. 31-34, it may be seen that the average transmittance of the P-polarized light is higher in the 400 nm-800 nm band; and the average transmittance of the S-polarized light is lower in the 400 nm-800 nm band. It is shown that the polarizing film 100 of embodiments 25-28 has a lower absorption loss.

The Tp and Tc at wavelengths of 450 nm, 550 nm, and 650 nm of the polarizing film 100 of embodiments 25-28, and the calculated values of extinction ratios, are shown in Table 6. As may be seen from the data in Table 6, the polarizing film 100 of embodiments 25-28 has a high extinction ratio.

TABLE 6
Table of test data for polarizing film 100 of embodiments 25-28

| Embodi- | | | | |
|---|---|---|---|---|
| ment | Wavelength | 450 nm | 550 nm | 650 nm |
| Embodi- | Transmittance Tp | 65.50% | 88.50% | 90.51% |
| ment 25 | Transmittance Tc | 1.26% | 1.49% | 1.71% |
| | Extinction ratio | 17.16 dB | 17.74 dB | 17.24 dB |
| | EXT | | | |
| Embodi- | Transmittance Tp | 70.74% | 84.57% | 87.80% |
| ment 26 | Transmittance Tc | 0.11% | 0.12% | 0.13% |
| | Extinction ratio | 28.08 dB | 28.48 dB | 28.30 dB |
| | EXT | | | |
| Embodi- | Transmittance Tp | 62.86% | 80.69% | 80.22% |
| ment 27 | Transmittance Tc | 0.00095% | 0.00076% | 0.00074% |
| | Extinction ratio | 48.2 dB | 50.81 dB | 50.35 dB |
| | EXT | | | |
| Embodi- | Transmittance Tp | 58.39% | 76.64% | 77.07% |
| ment 28 | Transmittance Tc | 0.000087% | 0.000061% | 0.000057% |
| | Extinction ratio | 58.27 dB | 60.99 dB | 61.31 dB |
| | EXT | | | |

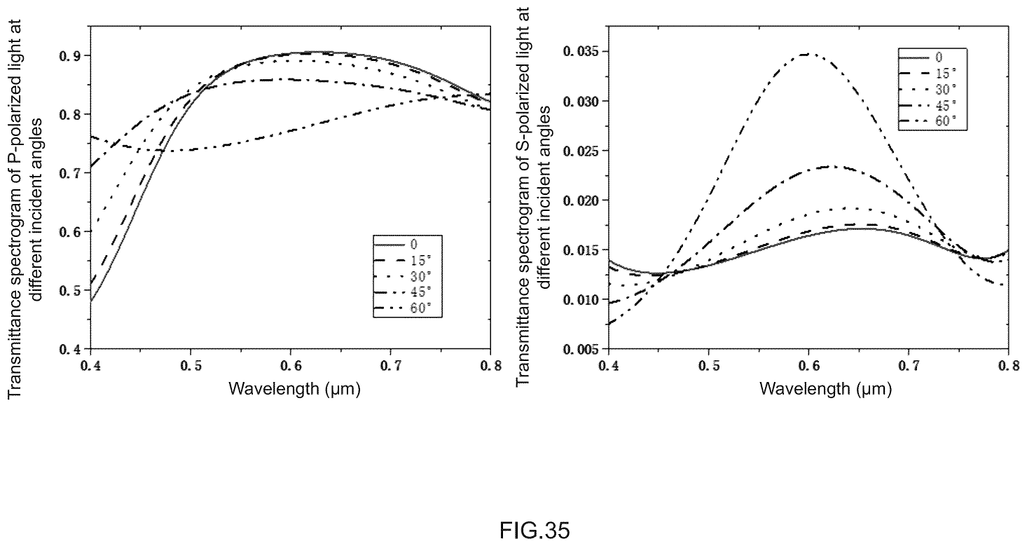

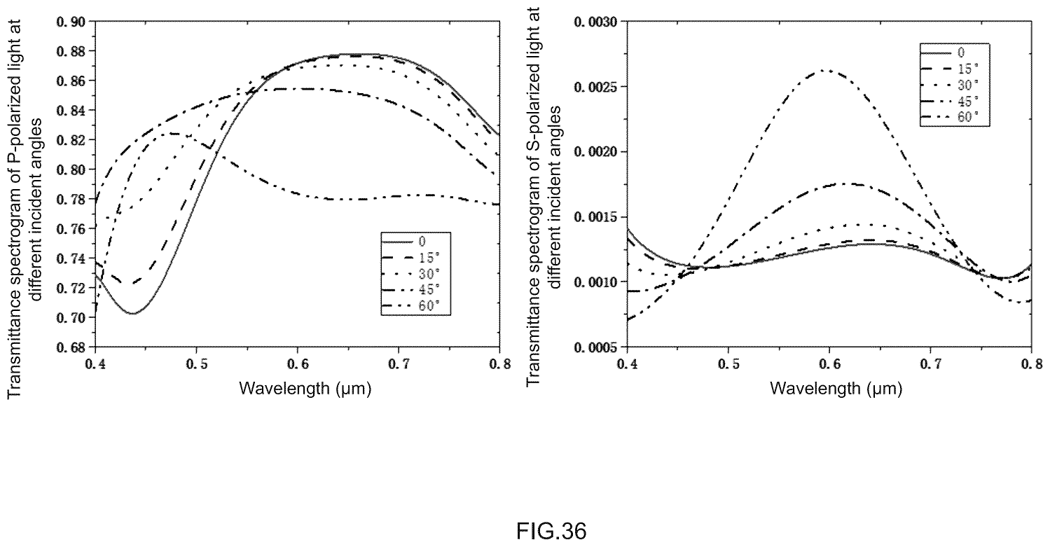

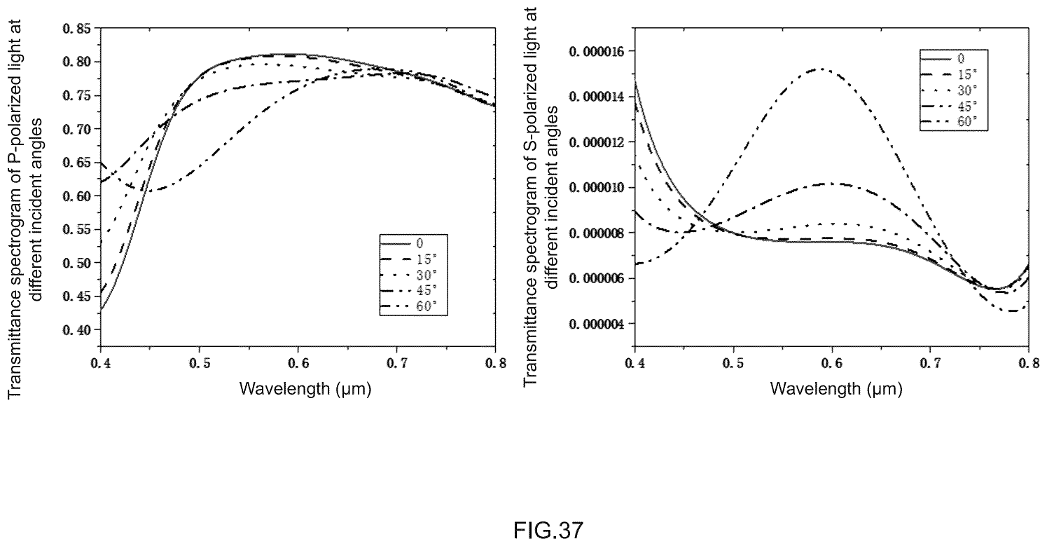

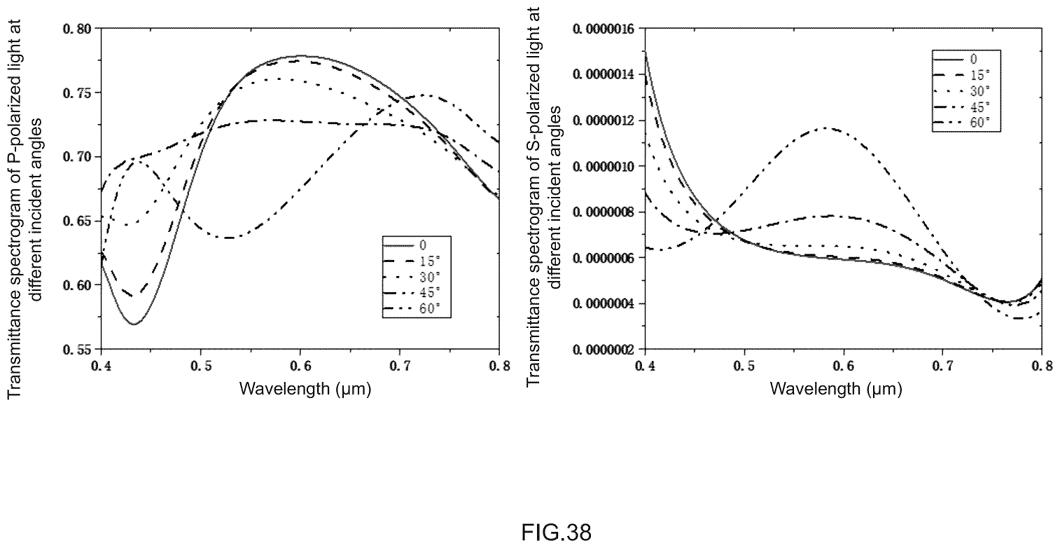

The polarizing film 100 of embodiments 25-28 was irradiated at different incident angles) (0-60° to obtain transmittance spectrogram of the P-polarized light and the S-polarized light at different incident angles, as shown in FIGS. 35-38. As may be seen from FIGS. 35-38, there is little effect on the transmittance spectrogram of the P-polarized light and the S-polarized light in the visible wavelength range when the incident angle is varied from 0-60°, suggesting that the polarizing film 100 of embodiments 25-28 is suitable for a wider incident angle.

### (10) Change in Thickness of Protective Layer H3

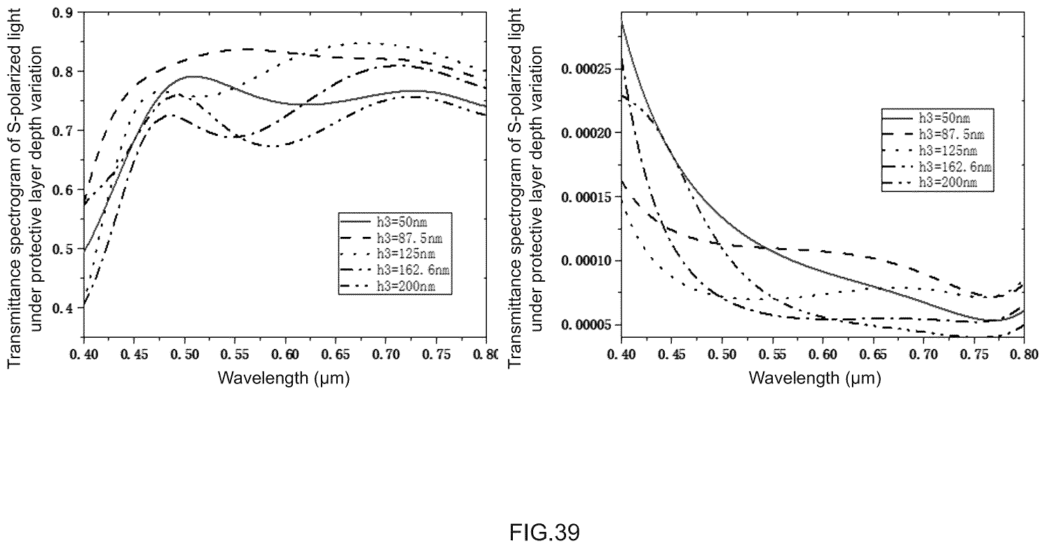

The polarizing film 100 of embodiments 29-33 was brought into the model for simulation to obtain the spectral effect of the transmittance rate of the P-polarized light and the S-polarized light in the visible band at 0 degree of incidence, as shown in FIG. 39. It may be seen from FIG. 39 that when the thickness h3 of the protective layer is varied between 50 nm and 200 nm, the transmittance of the P-polarized light in the visible wavelength range does not change much; the transmittance of the S-polarized light in the visible wavelength range does not change much with the increase of the depth h3.

By calculating the Tp and Tc at wavelengths of 450 nm, 550 nm, and 650 nm of the polarizing film 100 of embodiment 33, the corresponding values of extinction ratios may be calculated, as shown in Table 7. From the data in Table 7, it may be seen that the polarizing film 100 of embodiment 33 has a lower absorption loss and a higher extinction ratio.

TABLE 7
Table of test data for the polarizing film 100 of embodiment 33

| Wavelength | 450 nm | 550 nm | 650 nm |
|---|---|---|---|
| Transmittance Tp | 68.32% | 69.40% | 71.38% |
| Transmittance Tc | 0.018% | 0.0071% | 0.0049% |
| Extinction ratio EXT | 35.79 dB | 39.90 dB | 41.63 dB |

The polarizing film of the present disclosure has a grating structure in which a dielectric grating and a metallic layer are set alternately, and due to the different refractive indices of the dielectric grating and the metallic layer, the value of the equivalent refractive indices of the S-polarized light and the P-polarized light is not the same, and when the S-polarized light irradiates the grating structure, the electrons of the metallic layer form an enhanced free oscillation in the direction of the grating line, causing the S-polarized light to form an enhanced reflection; when the P-polarized light is irradiated, the electron oscillation through the direction of the grating line is impeded, and the transmission of the P-polarized light is enhanced at that time, and thus, the polarizing film of the present disclosure possesses the optical performance of reducing the absorption loss and improving the extinction ratio. In addition, the polarizing film designed in the present disclosure has a large angular tolerance, which is very suitable for large angle applications. Thus, it is able to combine the optical performance of low absorption loss, high extinction ratio, and wide incident angle, which is favorable for a wide range of applications.

It should be noted that the above descriptions are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of embodiment only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about,” “approximately,” or “substantially” in some examples. Unless otherwise stated, “about,” “approximately,” or “substantially” indicates that the number is allowed to vary by ±20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an embodiment and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A polarizing film, comprising:
a transparent substrate;
a grating layer disposed on the transparent substrate, the grating layer including dielectric gratings and metallic layers periodically arranged at intervals along a direction parallel to a surface of the transparent substrate; and
a protective layer covering the grating layer.

2. The polarizing film of claim 1, wherein a period of the dielectric gratings is in a range of 50 nm-150 nm, a duty ratio of the dielectric gratings is in a range of 0.25-0.75, and a thickness of the dielectric gratings is in a range of 60 nm-200 nm.

3. The polarizing film of claim 2, wherein a material of the dielectric gratings is a resin-based curing adhesive, and the dielectric gratings and the metallic layers have identical thicknesses.

4. The polarizing film of claim 1, wherein a refractive index of the transparent substrate is in a range of 1.4-2, and a refractive index of the dielectric gratings is in a range of 1.4-2.

5. The polarizing film of claim 1, wherein the transparent substrate is a flexible substrate.

6. The polarizing film of claim 5, wherein a material of the flexible substrate is at least one of polycarbonate, polyvinyl chloride, polyethylene terephthalate, polymethyl methacrylate, polypropylene, and cellulose triacetate.

7. The polarizing film of claim 1, wherein a thickness of the transparent substrate is in a range of 0.01 mm-1 mm.

8. The polarizing film of claim 1, wherein a refractive index of the protective layer is in a range of 1.3-1.8, and a thickness of the protective layer is in a range of 50 nm-200 nm.

9. The polarizing film of claim 1, wherein a material of the protective layer is at least one of SiO₂, MgF₂, and SiON.

10. The polarizing film of claim 1, wherein a material of the metallic layers is at least one of gold, silver, copper, aluminum, and tungsten.

11. A method for preparing a polarizing film, comprising:
forming a grating layer on a transparent substrate, wherein the grating layer includes dielectric gratings and metallic layers periodically arranged at intervals along a direction parallel to a surface of the transparent substrate, and the dielectric gratings and the metallic layers have identical thicknesses; and
forming a protective layer on the grating layer to obtain the polarizing film.

12. The method of claim 11, wherein the forming the grating layer on the transparent substrate includes:
forming the dielectric gratings periodically arranged at intervals along the direction parallel to the surface of the transparent substrate via nanoimprint lithography, wherein a groove is between two adjacent dielectric gratings; and
forming a metallic layer precursor on the dielectric gratings via a coating process, and removing the metallic layer precursor on a side of the dielectric gratings away from the transparent substrate while retaining the metallic layer precursor in the groove to form the metallic layers.

13. The method of claim 12, wherein the forming the dielectric gratings periodically arranged at intervals along the direction parallel to the surface of the transparent substrate via nanoimprint lithography includes:
bonding the transparent substrate to an imprinting template, wherein an imprinting adhesive is covered between the transparent substrate and the imprinting template;
pressing the transparent substrate and the imprinting template together; and
demolding the imprinting template from the cured imprinting adhesive to form the dielectric gratings periodically arranged at intervals along the direction parallel to the surface of the transparent substrate.

14. The method of claim 11, wherein the forming the protective layer on the dielectric gratings and the metallic layers includes forming the protective layer on the dielectric gratings and the metallic layers via a coating process.

15. A display device, comprising the polarizing film of claim 1, wherein the display device is a projector, a polarizing beam splitter prism, or a heads-up display.

16. An optical waveguide lens, comprising:
an optical waveguide having a light-receiving surface configured to receive light and a backlight surface disposed opposite the light-receiving surface; and
the polarizing film of claim 1 disposed on the backlight surface of the optical waveguide, wherein the transparent substrate of the polarizing film is arranged away from the optical waveguide;
wherein a gap is between the optical waveguide and the polarizing film.

17. The optical waveguide lens of claim 16, wherein the polarizing film has a transmittance of less than 5% for S-polarized light and a transmittance of at least 60% for P-polarized light.

18. The optical waveguide lens of claim 16, wherein a distance between the optical waveguide and the polarizing film is in a range of 1 μm-5 cm.

19. The optical waveguide lens of claim 16, wherein the polarizing film is fixed to the optical waveguide via a bonding adhesive, and the bonding adhesive is disposed at edge regions of the polarizing film and the optical waveguide.

20. The optical waveguide lens of claim 16, further including a rigid substrate configured to support the polarizing film, wherein the rigid substrate is bonded to a side of the polarizing film away from the optical waveguide.
